(19) United States
(12) Patent Application Publication
(10) Pub. No.: US 2025/0305973 A1
(43) Pub. Date: Oct. 2, 2025

(54) METHOD AND SYSTEM FOR DETERMINING AND MONITORING THERMAL PROPERTIES OF A BATHING UNIT SYSTEM AND FOR USING SAME TO CONTROL THE BATHING UNIT SYSTEM

(71) Applicant: Gecko Alliance Group Inc., Québec (CA)

(72) Inventors: Guillaume TREMBLAY, Québec (CA); Louis NOLLET, Québec (CA)

(21) Appl. No.: 18/745,455

(22) Filed: Jun. 17, 2024

Related U.S. Application Data
(60) Provisional application No. 63/573,360, filed on Apr. 2, 2024.

(51) Int. Cl. G01N 25/18

(52) U.S. Cl. CPC G01N 25/18

(57) ABSTRACT

A method and system are provided for operating components in a bathing unit system based its thermal properties. The bathing unit system comprises a receptacle holding water, a water temperature sensor, a temperature change component and an insulating component. The method includes activating the temperature change component until the water temperature reaches a target calibration temperature and then deactivating it. A thermal property indicator conveying a current condition of the insulating component is then derived based on the rate of change of the water temperature. The temperature change component is then controlled to achieve a target bathing temperature based at least in part on the thermal property indicator. In another aspect, a condition of the insulating component is monitored over time and notifications are sent conveying a condition (or a change in condition) of the insulating component and/or that the insulating component should be replaced or repaired.

### CROSS-REFERENCE TO RELATED APPLICATION

This application claims the benefit of U.S. provisional application No. 63/573,360 filed Apr. 2, 2024, which is incorporated by reference herein in its entirety.

### TECHNICAL FIELD

The present disclosure relates generally to monitoring and controlling bathing unit systems including, but not limited to, a swimming pool, a spa, a hot tub, and other recreational and therapeutic bodies of water. The present disclosure relates more specifically to determining and monitoring thermal properties of a bathing unit system and of using information pertaining to such thermal properties to provide improved energy efficiency when operating the bathing unit system.

### BACKGROUND

A bathing unit system typically includes various bating unit components such as a receptacle holding water, one or more pumps to circulate water in a circulation system comprising a plurality of conduits, one or more temperature change modules (e.g., heaters to increase the water temperature and coolers to decrease the water temperature), a filter system to filter the water and a control system for activating and managing the various components. Generally, a bathing unit system further includes insulating components configured to assist in maintaining a temperature of the water held in the receptacle. The insulating components may include a cover for the receptacle (also referred to herein as a “spa cover”), insulation within a cabinet surrounding the contour of the receptable (also referred to herein as “cabinet insulation”) and other insulating accessories such as a blanket which floats on top of the water within the receptacle. In some embodiments, the insulating components may also include the actual material of the receptacle itself (also referred to herein as “receptacle insulation”) as well insulating panels surrounding the lower part of the receptacle, behind the spa skirt.

During a typical operation, a user can specify a desired (e.g., target) bathing temperature via a control panel and the control system is generally configured for operating bathing unit components, including activating the one or more temperature change components, the one or more pumps and/or various components based on temperature sensor information in order for the water to reach (and/or be maintained at) the desired bathing temperature. As may be appreciated, changing a water temperature (either increasing or decreasing it) may take some time as a result of thermal inertia, or heat capacity, of the bathing unit system. As such, if a user would like to use a bathing unit system at a certain time and would like the water to be at a certain bathing temperature when it is used, the control system needs to activate the one or more temperature change components, one or more pumps and/or various components in advance of that certain time.

However, activating bathing unit components (and in particular the temperature change components) consume significant amounts of energy, which results in increased operating costs of the bathing unit system as energy costs continue to rise. As such, it is considered desirable to reduce the amount of time the bathing unit components are activated in order to reduce energy consumption and cost. While various systems have been proposed for controlling activation of bathing unit components, conventional systems fail to provide suitable solutions for managing the activation of bathing unit components, and in particular the temperature change components, while limiting the impact on the user's enjoyment of the bathing unit system that take into account conditions specific to the bathing unit system being controlled. In addition, conventional systems fail to provide solutions that monitor conditions intrinsic and/or extrinsic to the bathing unit system and suitably adapt the way bathing unit components are controlled over time to take into account the changes in such conditions. For example, conventional systems fail to suitably take into account the deterioration of insulating components of the bathing unit system. As a result, to achieve a desired temperature by a desired time, such conventional system often waste energy by activating components of the bathing too early when a later activation time may have been suitable to achieving user comfort.

Against the background above, there is a need in the industry to provide improved methods and systems for operating one or more components in a bathing unit system that take into account conditions specific to the bathing unit system and/or that adapt the way bathing unit components may be controlled over time to take into account changes in such conditions. This may allow for more refined control of other bathing unit components of a particular bathing unit system (and in particular, those components which function to input thermal energy into the water) and also may alleviate at least in part some of the problems associated with a deteriorating insulating component.

### SUMMARY

In accordance with a general aspect, the present disclosure proposes to provide a method for operating one or more bathing unit components in a bathing unit system at least in part based on thermal properties of that specific bathing unit system being controlled. The thermal properties may, for example, be correlated with an insulating capacity of one or more insulating components of the bathing unit system. It is to be appreciated that the thermal properties may vary from one bathing unit system to the other and may change over time as material of the insulating components age due to exposure to temperature, sun and other environmental conditions.

The inventors have noted that the insulating components of a bathing unit system, and in particular corresponding insulating capacity of each of the insulating components, influences how much thermal energy is required to be inputted into water in the receptacle of the bathing unit system in order for the water to reach (and/or be maintained at) a desired bathing temperature. Since thermal properties may vary from one bathing unit system to the next, by providing mechanisms for quantifying the thermal properties specific to a particular bathing unit system, and for controlling bathing unit components (e.g., temperature change components and/or pumps) to achieve a target bathing temperature based at least in part on the derived thermal properties specific to the bathing unit system, a more precise and customized control of the bathing unit components may be achieved.

Additionally, the inventors have noted that, as the effectiveness of insulating components deteriorates over time, the corresponding insulating capacity of the insulating components may also deteriorate. As a result, as insulating components age, additional thermal energy may be required to be inputted into the water in order for the water to reach the desired bathing temperature or to be maintained at the desired bathing temperature, which may be reflected by a change in the thermal properties of a bathing unit system. By providing mechanisms for monitoring over time changes in a condition of the insulating component(s) and of using such changes to adjust control of the bathing unit components (e.g., such as temperature change components and/or pumps) further improves the precision and customized control of the bathing unit components.

To operate one or more bathing unit components at least in part based on thermal properties of the specific bathing unit system being controlled, a problem to be addressed is how to derive a thermal property indicator for the specific bathing unit system. The phrase “thermal property indicator” as used herein means without limitation a metric indicative of an ability of a particular bathing unit system to conduct (or inversely, resist) thermal energy, and in particular thermal energy inputted into water in a receptacle of the particular bathing unit system. In some embodiments described herein, the phrase “thermal property indicator” may refer to a k constant representing a rate of temperature change of the water in the receptacle of the particular bathing unit system when no further thermal energy is inputted into the water, a thermal conductivity H of the particular bathing unit system and an inverse thermal resistance Θ of the particular bathing unit system. The k constant may be used to calculate at least the thermal conductivity H and the inverse thermal resistance Q. As described above and below, the properties of a particular bathing unit system may be primarily correlated to an insulating capacity (e.g., correlated to condition) of at least one insulating component of the specific bathing unit system being controlled.

Another problem sought to be addressed involves how to decrease energy costs associated with operation of, and also how to refine operation of, different bathing unit components of a specific bathing unit system. In some embodiments described herein, the derived thermal property indicator for a specific bathing unit system may be used to control operation of the different bathing unit components of that specific bathing unit system, and in particular operation of bathing unit components which are responsible for inputting thermal energy into the water of the specific bathing unit system (e.g., temperature change components and/or pumps). The phrase “temperature change component” as used herein means, without limitation, a component which primarily functions to change a temperature of water of a particular bathing unit system, and includes at least a heater or heating module, a cooler or cooling module, or a combination heater/cooler or cooling/heating module such as a heat transfer module like a heat pump. In some embodiments, one or more pumps of the specific bathing unit system may also contribute to inputting thermal energy into the water, such as by agitating the water within a circulation system and/or due to the heat generated by a motor of the pump in a cabinet of the particular bathing unit system and which is transferred through the receptacle and into the water. Using the determined thermal property indicator to control the operation of different bathing unit components may optimize a temperature change process for heating or cooling the water (e.g., increased energy efficiency and/or provide the water at a target bathing temperature and at a target time).

Another problem sought to be addressed involves monitoring a condition of an insulating component of a particular bathing system in order to ensure that an insulating capacity (e.g., correlated to the condition) of the insulating component remains adequate. In some embodiments described herein, changes in the thermal property of a particular bathing unit system may be used to determine a condition of an insulating component and to recommend replacement or repair of the at least one insulating component. The phrase “insulating component” as used herein means without limitation a component which functions to insulate thermal energy of water within a receptacle of a particular bathing unit system. In embodiments described herein, the phrase “insulating component” as used herein refers to one or more of a cover for the receptacle (also referred to herein as a “spa cover”), insulation within a cabinet of the bathing unit system (also referred to herein as “cabinet insulation”) and other insulating accessories such as a blanket which floats on top of the water within the receptacle. In some embodiments, the at least one insulating component may also include the actual material of the receptacle itself (also referred to herein as “receptacle insulation”).

In some aspects, the embodiments described herein relate to a method for operating one or more components in a bathing unit system at least in part based on thermal properties of the bathing unit system, wherein the bathing unit system further includes a receptacle holding water and at least one insulating component insulating the receptacle, the method including: (a) deriving a thermal property indicator for the bathing unit system at least in part by processing changes in temperature of the water in the bathing unit system and/or deriving energy information corresponding to the one or more components, the thermal property indicator conveying a current condition of the at least one insulating component; and (b) controlling the one or more components to achieve a target bathing temperature based at least in part on the thermal property indicator.

Deriving the thermal property indicator may include deriving the thermal property indicator by processing the changes in the temperature of the water. Processing the changes in the temperature of the water may include: (a) activating a temperature change component for changing the temperature of the water to change the temperature of the water to a target calibration temperature; (b) deactivating the temperature change component responsive to the water reaching the target calibration temperature; (c) following deactivation of the temperature change component, deriving a rate of change of the temperature of the water at least in part by processing temperature measurements obtained by a sensor for measuring the temperature of the water at a plurality of determination time points over a determination time period; and (d) deriving the thermal property indicator for the bathing unit system at least in part by processing the rate of change of the temperature of the water.

The temperature change component may include at least one heater, and wherein: (a) activating the temperature change component may include activating the at least one heater to increase the temperature of the water to the target calibration temperature; and (b) deactivating the temperature change component may include deactivating the at least one heater prior to determining the rate of change of the temperature of the water. The rate of change of the temperature of the water may convey a rate of cooling of the water.

The temperature change component may include at least one cooler, and wherein: (a) activating the temperature change component may include activating the at least one cooler to decrease the temperature of the water to the target calibration temperature; and (b) deactivating the temperature change component may includes deactivating the at least one cooler prior to determining the rate of change of the temperature of the water. The rate of change of the temperature of the water may convey a rate of heating of the water.

Deriving the thermal property indicator may include deriving the energy information corresponding to the one or more components. Deriving the energy information corresponding to the one or more components may include: (a) deriving power consumption information of the one or more components; and/or (b) deriving thermal energy information of the one or more components.

Deriving the power consumption information of the one or more components may include deriving the power consumption information based on a power consumption model generated for the one or more components. The power consumption model may model an amount of power drawn by the one or more components from a power source and/or or an amount of power inputted by the one or more components into the water. Deriving the thermal energy information of the one or more components may include deriving the thermal energy information based on a thermal energy model generated for the one or more components. The thermal energy model may model an amount of thermal energy inputted into the water and/or drawn from the water by the one or more components.

The one or more components may include a temperature change component for changing the temperature of the water and/or a pump for circulating the water through a circulation system of the bathing unit system.

Deriving the thermal property indicator further includes processing a current ambient temperature of an environment around the bathing unit system.

The method may further include: (a) retrieving extrinsic parameters of the bathing unit system, the extrinsic parameters including the thermal property indicator and at least one other extrinsic parameter; (b) receiving an input command conveying the target bathing temperature; and (c) adjusting control of the one or more components to achieve the target bathing temperature at least in part by processing the extrinsic parameters.

The extrinsic parameters may further include at least one of: a current water temperature of the water within the receptacle, a current water temperature of the water within the bathing unit system, a current ambient temperature of an environment around the bathing unit system, a forecasted ambient temperature of the environment around the bathing unit system, an amount of thermal energy inputted into or drawn from the bathing unit system over time based on thermal energy models of the one or more components, and a cost of energy associated with operating the one or more components based on power consumption models of the one or more components.

The input command may further include at least one of: an initial time point for activating the one or more components and a final time point at which the bathing unit system achieves the target bathing temperature.

The thermal property indicator may be a reference thermal property indicator conveying a reference condition of the at least one insulating component. The method may further include: (a) deriving a subsequent thermal property indicator at a subsequent determination time point after a monitoring time period, the subsequent thermal property indicator conveying a subsequent current condition of the at least one insulating component after the monitoring time period; and (b) deriving change information for the thermal properties of the bathing unit system at least in part by comparing the subsequent thermal property indicator and the reference thermal property indicator.

The change information may convey: (a) a percentage of deterioration of the at least one insulating component over the monitoring time period; (b) a rate of deterioration of the at least one insulating component over the monitoring time period; and/or (c) a change in condition of the at least one insulating component over the monitoring time period.

The reference thermal property indicator may be one of an initial thermal property indicator or a previously derived thermal property indicator.

The method any further involve adjusting control of the one or more components to achieve the target bathing temperature based at least in part on the change information and the subsequent thermal property indicator.

The method may further include transmitting one or more notification messages to a user of the bathing unit system in response to the change information. The one or more notification messages may convey: (a) information derived by processing the subsequent thermal property indicator; (b) that changes in the thermal properties of the bathing unit system exceed a threshold level; (c) the reference condition of the at least one insulating component conveyed by the reference thermal property indicator; (d) the subsequent current condition of the at least one insulating component conveyed by the subsequent thermal property indicator; (e) the change information; and/or (f) that the at least one insulating component should be replaced or repaired.

The at least one insulating component may includes at least one of a cover of the bathing unit system, a receptacle insulation of the bathing unit system or a cabinet insulation of the bathing unit system.

In some aspects, the embodiments described herein relate to a system for operating one or more components in a bathing unit system at least in part based on thermal properties of the bathing unit system. The bathing unit system further includes a receptacle holding water and at least one insulating component insulating the receptacle. The system includes: (a) at least one processor; and (b) a memory storing processor-executable instructions. The processor-executable instructions, when executed, cause the at least one processor to: (i) derive a thermal property indicator for the bathing unit system at least in part by processing changes in a temperature of the water in the bathing unit system and/or deriving energy information corresponding to the one or more components, the thermal property indicator conveying a current condition of the at least one insulating component; and (ii) control the one or more components to achieve a target bathing temperature based at least in part on the thermal property indicator.

In some aspects, the embodiments described herein relate to a non-transitory computer-readable medium having stored thereon processor-executable instructions for implementing a method for operating one or more components in a bathing unit system at least in part based on thermal properties of the bathing unit system. The bathing unit system further includes a receptacle holding water and at least one insulating component insulating the receptacle. The processor-executable instructions are configured to cause at least one processor to: (i) derive a thermal property indicator for the bathing unit system at least in part by processing changes in a temperature of the water and/or deriving energy information corresponding to the one or more components, the thermal property indicator conveying a current condition of the at least one insulating component; and (ii) control the one or more components to achieve a target bathing temperature based at least in part on the thermal property indicator.

In some aspects, the embodiments described herein relate to a method for operating one or more components in a bathing unit system at least in part based on thermal properties of the bathing unit system. The bathing unit system includes a receptacle holding water, a sensor for measuring a temperature of the water, a temperature change component for changing a temperature of the water and at least one insulating component insulating the receptacle. The method involves: (a) activating the temperature change component to change the temperature of the water to a target calibration temperature; (b) deactivating the temperature change component responsive to the water reaching the target calibration temperature; (c) following deactivation of the temperature change component, deriving a rate of change of the temperature of the water at least in part by processing temperature measurements obtained by the sensor at a plurality of determination time points over a determination time period; (d) deriving a thermal property indicator for the bathing unit system at least in part by processing the rate of change of the temperature of the water, the thermal property indicator conveying a current condition of the at least one insulating component; and (e) controlling the temperature change component to achieve a target bathing temperature based at least in part on the thermal property indicator.

In some aspects, the embodiments described herein relate to a system for operating one or more components in a bathing unit system at least in part based on thermal properties of the bathing unit system. The bathing unit system includes a receptacle holding water, a sensor for measuring a temperature of the water, a temperature change component for changing a temperature of the water and at least one insulating component insulating the receptacle. The system includes: (a) at least one processor; and (b) a memory storing processor-executable instructions. The processor-executable instructions, when executed, cause the at least one processor to: (i) activate the temperature change component to change the temperature of the water to a target calibration temperature; (ii) deactivate the temperature change component in response to the water reaching the target calibration temperature; (iii) derive a rate of change of the temperature of the water in response to deactivation of the temperature change component and at least in part by processing temperature measurements obtained by the sensor at a plurality of determination time points over a determination time period; (iv) derive a thermal property indicator for the bathing unit system at least in part by processing the derived rate of change of the temperature of the water, the thermal property indicator conveying a current condition of the at least one insulating component; and (v) control the temperature change component to achieve a target bathing temperature based at least in part on the thermal property indicator.

In some aspects, the embodiments described herein relate to a non-transitory computer-readable storage medium having stored thereon processor-executable instructions that, when executed, implement a system for operating one or more components in a bathing unit system at least in part based on thermal properties of the bathing unit system. The bathing unit system includes a receptacle holding water, a sensor for measuring a temperature of the water, a temperature change component for changing a temperature of the water and at least one insulating component insulating the receptacle. The processor-executable instructions are configured to cause at least one processor to: (a) activate the temperature change component to change the temperature of the water to a target calibration temperature; (b) deactivate the temperature change component in response to the water reaching the target calibration temperature; (c) derive a rate of change of the temperature of the water in response to the deactivation of the temperature change component and at least in part by processing temperature measurements obtained by the sensor at a plurality of determination time points over a determination time period; (d) derive a thermal property indicator for the bathing unit system at least in part by processing the derived rate of change of the temperature of the water, the thermal property indicator conveying a current condition of at least one insulating component of the bathing unit system; and (e) control the temperature change component to achieve a target bathing temperature based at least in part on the thermal property indicator.

In some aspects, the embodiments described herein relate to a method for monitoring at least one insulating component of a bathing unit system, the bathing unit system including a receptacle for holding water and one or more components for operating the bathing unit system, the at least one insulating component providing insulation of the receptacle. The method includes: (a) deriving a reference thermal property indicator for the bathing unit system at least in part by processing changes in a temperature of the water over a determination time period and/or deriving energy information corresponding to the one or more components over the determination time period, wherein the reference thermal property indicator includes one of an initial reference thermal property indicator and a previously derived thermal property indicator and conveys a reference condition of the at least one insulating component; (b) waiting a monitoring time period; (c) repeating step (a) after the monitoring time period to derive a subsequent thermal property indicator, the subsequent thermal property indicator conveying a current condition of the at least one insulating component after the monitoring time period; (d) deriving change information conveying changes in a condition of the at least one insulating component over the monitoring time period derived at least in part by comparing the subsequent thermal property indicator and the reference thermal property indicator; (e) transmitting one or more notification messages to a user of the bathing unit system in response to the change information. The one or more notification messages conveys: (i) that the changes in the condition of the at least one insulating component exceed a threshold level; (ii) the reference condition of the at least one insulating component conveyed by the reference thermal property indicator; (iii) the current condition of the at least one insulating component conveyed by the subsequent thermal property indicator; (iv) the change information; and/or (v) that the at least one insulating component should be replaced or repaired.

Deriving the reference thermal property indicator may includes deriving the reference thermal property indicator by processing the changes in the temperature of the water within the receptacle over the determination time period. Processing the changes in temperature of the water may include: (a) activating a temperature change component for changing a temperature of the water to change the temperature of the water to a target calibration temperature; (b) deactivating the temperature change component responsive to the water reaching the target calibration temperature; (c) following deactivation of the temperature change component, deriving a rate of change of the temperature of the water at least in part by processing temperature measurements obtained by a sensor for measuring the changes in the temperature of the water at a plurality of determination time points over the determination time period; and (d) deriving the reference thermal property indicator for the bathing unit system at least in part by processing the rate of change of the temperature of the water.

The temperature change component may include at least one heater. Determining the rate of change of the temperature of the water may include determining a rate of cooling of the water after the temperature of the water reaches the target calibration temperature and after the at least one heater is deactivated.

The temperature change component may include at least one cooler. Determining the rate of change of the temperature of the water may includes determining a rate of heating of the temperature of the water after the temperature of the water reaches of the target calibration temperature and after the at least one cooler is deactivated.

Deriving the reference thermal property indicator may include deriving the energy information corresponding to the one or more components. Deriving the energy information corresponding to the one or more components may include: (a) deriving power consumption information of the one or more components; and/or (b) deriving thermal energy information of the one or more components.

Deriving the power consumption information of the one or more components may includes deriving the power consumption information based on a power consumption model generated for the one or more components. The power consumption model may model an amount of power drawn by the one or more components from a power source and/or an amount of power inputted by the one or more components into the water. Deriving the thermal energy information of the one or more components may include deriving the thermal energy information based on a thermal energy model generated for the one or more components. The thermal energy model may model an amount of thermal energy inputted into the water and/or drawn from the water by the one or more components.

The one or more components may include a temperature change component for changing a temperature of the water and/or a pump for circulating the water through a circulation system of the bathing unit system.

Deriving the reference thermal property indicator may further include processing a current ambient temperature of an environment around the bathing unit system.

The change information may convey: (a) a percentage of deterioration of thermal insulation of the at least one insulating component over the monitoring time period; and/or (b) a rate of deterioration of thermal insulation of the at least one insulating component over the monitoring time period.

The at least one insulating component may include at least one of a cover of the bathing unit system, a receptacle insulation of the bathing unit system or a cabinet insulation of the bathing unit system. Deriving the change information includes: (a) determining changes in a condition of the cover; (b) determining changes in a condition of the receptacle insulation; and/or (c) determining changes in a condition of the cabinet insulation.

The one or more notification messages may be in the form of SMS text messages sent to a personal communication device associated with the user, wherein the SMS text messages include a user-operable input for establishing a communication exchange with at least one of an online marketplace and a specific supplier.

The one or more notification messages may be configured for rendering a graphical user interface on a display screen. The graphical user interface may present a user with (i) information derived from the one or more notification messages; and (ii) a user-operable input element configured for receiving a user command initiating at least one of a repair process or a purchase process in connection with the at least one insulating component.

In some aspects, the embodiments described herein relate to a system for monitoring at least one insulating component of a bathing unit system. The bathing unit system includes a receptacle for holding water and one or more components for operating the bathing unit system, the at least one insulating component providing insulation of the receptacle. The system includes: (a) at least one processor; and (b) a memory storing processor-executable instructions. The processor-executable instructions, when executed, cause the at least one processor to: (i) derive a reference thermal property indicator for the bathing unit system at least in part by processing changes in a temperature of the water over a determination time period and/or deriving energy information corresponding to the one or more components over the determination time period, wherein the reference thermal property indicator includes one of an initial reference thermal property indicator and a previously derived thermal property and conveys a reference condition of the at least one insulating component; (ii) wait a monitoring time period; (iii) repeat step (i) after the monitoring time period to derive a subsequent thermal property indicator, the subsequent thermal property indicator conveying a current condition of the at least one insulating component after the monitoring time period; (iv) derive change information conveying changes in a condition of the at least one insulating component over the monitoring time period at least in part by comparing the subsequent thermal property indicator and the reference thermal property indicator; (v) transmit one or more notification messages to a user of the bathing unit system in response to the change information. The one or more notification messages convey: (a) that changes in the condition of the at least one insulating component exceed a threshold level; (b) the reference condition of the at least one insulating component conveyed by the reference thermal property indicator; (c) the current condition of the at least one insulating component conveyed by the subsequent thermal property indicator; (d) the change information; and/or (e) that the at least one insulating component should be replaced or repaired.

In some aspects, the embodiments described herein relate to a non-transitory computer-readable storage medium having stored thereon processor-executable instructions that, when executed, implement a system for monitoring at least one insulating component of a bathing unit system. The bathing unit system includes a receptacle for holding water and one or more components for operating the bathing unit system, the at least one insulating component providing insulation of the receptacle, said processor-executable instructions being configured to cause at least one processor to: (a) derive a reference thermal property indicator for the bathing unit system at least in part by processing changes in a temperature of the water over a determination time period and/or deriving energy information corresponding to the one or more components over the determination time period, wherein the reference thermal property indicator includes one of an initial reference thermal property indicator and a previously derived thermal property indicator and conveys a reference condition of the at least one insulating component; (b) wait a monitoring time period; (c) repeat step (a) after the monitoring time period to derive a subsequent thermal property indicator, the subsequent thermal property indicator conveying a current condition of the at least one insulating component after the monitoring time period; (d) derive change information conveying changes in a condition of the at least one insulating component over the monitoring time period derived at least in part by comparing the subsequent thermal property indicator and the reference thermal property indicator; and (e) transmit one or more notification messages to a user of the bathing unit system in response to the change information. The one or more notification messages conveys: (i) that changes in the condition of the at least one insulating component exceed a threshold level; (ii) the reference condition of the at least one insulating component conveyed by the reference thermal property indicator; (iii) the current condition of the at least one insulating component conveyed by the subsequent thermal property indicator; (iv) the change information; and/or (v) that the at least one insulating component should be replaced or repaired.

In some aspects, the embodiments described herein relate to a method for monitoring at least one insulating component of a bathing unit system. The bathing unit system includes a receptacle for holding water, a sensor for measuring a temperature of the water and a temperature change component for changing the temperature of the water, the at least one insulating component providing insulation of the receptacle. The method involves: (a) deriving a reference thermal property indicator for the bathing unit system at least in part by determining a rate of change of the temperature of the water based on temperature measurements obtained by the sensor at a plurality of determination time points over a determination time period after the temperature of the water reaches a target calibration temperature and after the temperature change component is deactivated, wherein the reference thermal property indicator includes one of an initial reference thermal property indicator and a previously derived thermal property indicator and conveys a reference condition of the at least one insulating component; (b) waiting a monitoring time period; (c) repeating step (a) after the monitoring time period to derive a subsequent thermal property indicator, the subsequent thermal property indicator conveying a current condition of the at least one insulating component after the monitoring time period; (d) deriving change information conveying changes in a condition of the at least one insulating component over the monitoring time period derived at least in part by comparing the subsequent thermal property indicator and the reference thermal property indicator; (e) transmitting one or more notification messages to a user of the bathing unit system in response to the change information. The one or more notification messages conveying: (i) that the changes in the condition of the at least one insulating component exceed a threshold level; (ii) the reference condition of the at least one insulating component conveyed by the reference thermal property indicator; (iii) the current condition of the at least one insulating component conveyed by the subsequent thermal property indicator; (iv) the change information; and/or (v) that the at least one insulating component should be replaced or repaired.

In some aspects, the embodiments described herein relate to a system for monitoring at least one insulating component of a bathing unit system. The bathing unit system includes a receptacle for holding water, a sensor for measuring a temperature of the water and a temperature change component for changing the temperature of the water, the at least one insulating component providing insulation of the receptacle. The system includes: (a) at least one processor; and (b) a memory storing processor-executable instructions. The processor-executable instruction, when executed, cause the at least one processor to: (i) derive a reference thermal property indicator for the bathing unit system at least in part by determining a rate of change of the temperature of the water based on temperature measurements obtained by the sensor at a plurality of determination time points over a determination time period after the temperature of the water reaches a target calibration temperature and after the temperature change component is deactivated, wherein the reference thermal property indicator includes one of an initial reference thermal property indicator and a previously derived thermal property indicator and conveys a reference condition of the at least one insulating component; (ii) wait a monitoring time period; (iii) repeat step (i) after the monitoring time period to derive a subsequent thermal property indicator, the subsequent thermal property indicator conveying a current condition of the at least one insulating component after the monitoring time period; (iv) derive change information conveying changes in a condition of the at least one insulating component over the monitoring time period derived at least in part by comparing the subsequent thermal property indicator and the reference thermal property indicator; and (v) transmit one or more notification messages to a user of the bathing unit system in response to the change information. The one or more notification messages conveys: (A) that changes in the condition of the at least one insulating component exceed a threshold level; (B) the reference condition of the at least one insulating component conveyed by the reference thermal property indicator; (C) the current condition of the at least one insulating component conveyed by the subsequent thermal property indicator; (D) the change information; and/or (E) that the at least one insulating component should be replaced or repaired.

In some aspects, the embodiments described herein relate to a non-transitory computer-readable storage medium having stored thereon processor-executable instructions that, when executed, implement a system for monitoring at least one insulating component of a bathing unit system. The bathing unit system includes a receptacle for holding water, a sensor for measuring a temperature of the water and a temperature change component for changing the temperature of the water, the at least one insulating component providing insulation of the receptacle. The processor-executable instructions are configured to cause at least one processor to: (a) derive a reference thermal property indicator for the bathing unit system at least in part by determining a rate of change of the temperature of the water based on temperature measurements obtained by the sensor at a plurality of determination time points over a determination time period after the temperature of the water reaches a target calibration temperature and after the temperature change component is deactivated, wherein the reference thermal property indicator includes one of an initial reference thermal property indicator and a previously derived thermal property indicator and conveys a reference condition of the at least one insulating component;

(b) wait a monitoring time period; (c) repeat step (a) after the monitoring time period to derive a subsequent thermal property indicator, the subsequent thermal property indicator conveying a current condition of the at least one insulating component after the monitoring time period; (d) derive change information conveying changes in a condition of the at least one insulating component over the monitoring time period derived at least in part by comparing the subsequent thermal property indicator and the reference thermal property indicator; and (e) transmit one or more notification messages to a user of the bathing unit system in response to the change information. The one or more notification messages conveys: (i) that changes in the condition of the at least one insulating component exceed a threshold level; (ii) the reference condition of the at least one insulating component conveyed by the reference thermal property indicator; (iii) the current condition of the at least one insulating component conveyed by the subsequent thermal property indicator; (iv) the change information; and/or (v) that the at least one insulating component should be replaced or repaired.

In some aspects, the embodiments described herein relate to a non-transitory computer-readable storage medium having stored thereon processor-executable instruction that, when executed, cause at least one processor to perform operations including: (a) receiving a notification message from a system monitoring an insulating component of a bathing unit system including condition information corresponding to the insulating component. The condition information conveys: (i) a current condition of the insulating component; and/or (ii) a level of degradation of the insulating component, the level of degradation being derived from a change between a current thermal property indicator for the insulating component and a reference thermal property indicator for the insulating component; (iii) that the insulating component should be replaced or repaired; and/or (iv) that the insulating component is missing. The operations further include (b) processing the notification message to render a graphical user interface on a display screen of a user device. The graphical user interface presenting a user with: (i) information conveying the condition information corresponding to the insulating component; and (ii) a user-operable input element configured for receiving a user command initiating at least one of a repair process or a purchase process in connection with the insulating component.

The reference thermal property indicator may include an initial thermal property indicator or a previously derived thermal property indicator.

The user-operable input element may be presented in response to the condition information conveying that the insulating component should be replaced or repaired.

The operations may further comprise, in response to receipt of the user command, establishing a communication exchange with at least one of an online marketplace and a specific supplier for the at least one of the repair process or the purchase process in connection with the insulating component. The communication exchange may be established between the user device and at least one of the online marketplace or the specific supplier.

The insulating component may include one of a receptacle insulation element or a cabinet insulation element.

The insulating component may be a spa cover.

The user device may be at least one of a top-side bathing unit control panel, a tablet, a smartphone and a computer device.

All features of embodiments which are described in this disclosure and are not mutually exclusive can be combined with one another. Elements of one embodiment can be utilized in the other embodiments without further mention. Other aspects and features of the present invention will become apparent to those ordinarily skilled in the art upon review of the following description of specific embodiments in conjunction with the accompanying Drawings.

### BRIEF DESCRIPTION OF THE DRAWINGS

A detailed description of the embodiments of the present invention is provided herein below, by way of example only, with reference to the accompanying drawings, in which:

FIG. 1 is a schematic diagram of a bathing unit system in accordance with one embodiment;

FIG. 2 is a perspective view of a receptacle of the bathing unit system of FIG. 1 including at least one insulating component in accordance with one embodiment;

FIG. 3 is a schematic diagram of a controller of the bathing unit system of FIG. 1 showing elements involved in operating one or more bathing unit components of the bathing unit system at least in part based on thermal properties of the bathing unit system in accordance with one embodiment;

FIG. 4 is a schematic diagram of a remote server in communication with the bathing unit system of FIG. 1 showing elements involved in operating one or more bathing unit components of the bathing unit system at least in part based on thermal properties of the bathing unit system in accordance with another embodiment;

FIGS. 5A and 5B are a flowcharts of process for deriving a thermal property indicator executed using at least one of the controller of FIG. 3 or the remote server of FIG. 4 in accordance with a specific example of implementation;

FIG. 6 is a flowchart of a process for deriving power consumption and thermal energy executed using at least one of the controller of FIG. 3 or the remote server of FIG. 4 in accordance with a specific example of implementation;

FIG. 7 is a flowchart of a process for controlling control temperature change of water of a bathing unit system executed using at least one of the controller of FIG. 3 or the remote server of FIG. 4 in accordance with a specific example of implementation;

FIG. 8 is a flowchart of a process for monitoring an insulating component of a bathing unit system, executed using at least one of the controller of FIG. 3 or the remote server of FIG. 4 in accordance with one embodiment; and

FIG. 9 is a user interface conveying one or more notification messages regarding an insulating component of a bathing unit system displayed on a user device associated with a user of the bathing unit system.

Throughout the appended drawings, like features are identified by like reference numerals. In the drawings, the embodiments are illustrated by way of examples. It is to be expressly understood that the description and drawings are only for the purpose of illustration and are an aid for understanding. They are not intended to be a definition of the limits of the present invention.

### DETAILED DESCRIPTION

The description below is directed to specific implementations and uses of embodiments of the invention in the context of bathing unit system. The phrase “bathing unit system” as used herein include without limitation spas/swim-spas, whirlpools, hot tubs, bath tubs, therapeutic baths and swimming pools and any other type of unit having a receptacle for holding water. Moreover, while specific embodiments have been described for use in the context of bathing unit systems, one skilled in the art will appreciate that, in view of the present description, alterative embodiments may be configured for use in any system including a body of water in which thermal properties of the system may be determined and/or thermal properties of the system may be used to adjust control of different components of the system and/or thermal properties of the system may be monitored over time, for example over a lifetime of the system, to determine a condition (and correlated to insulative capacity) of at least one insulating component of the system.

### Bathing Unit System 100

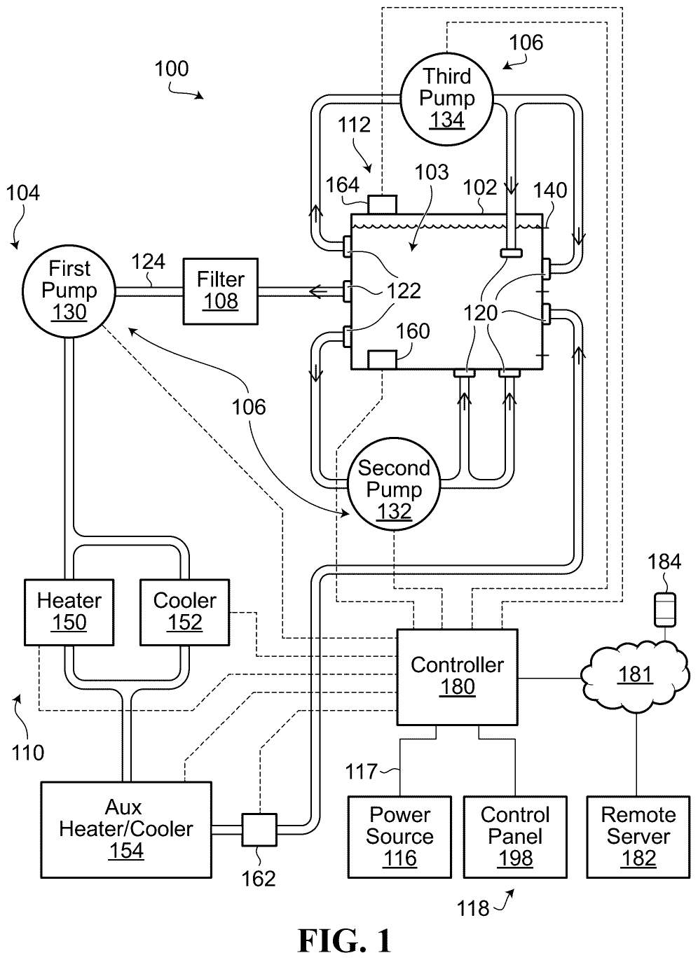

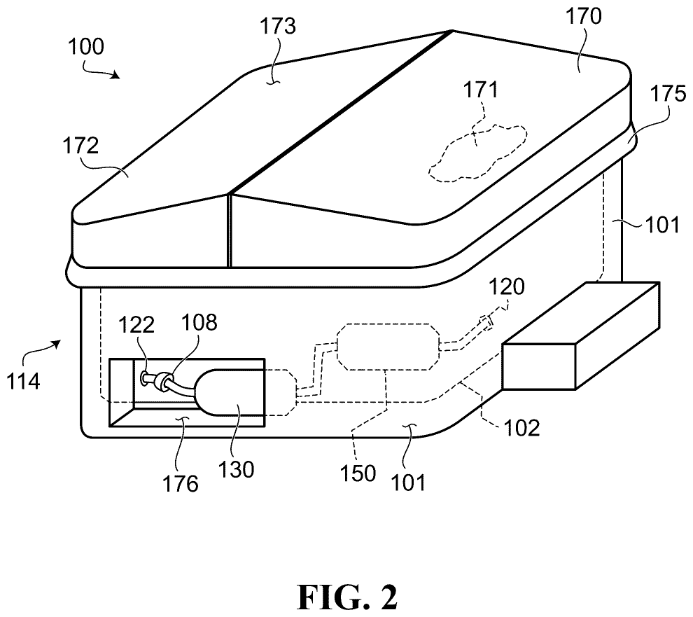

One embodiment of a bathing unit system 100 is shown in FIGS. 1 and 2. In the embodiment shown, the bathing unit system 100 includes a cabinet 101 housing a receptacle 102 for holding water 103. The receptacle 102 includes a plurality of water inlets 120 (five are shown in FIG. 1) which will typically be connected to respective jets and a plurality of water outlets 122 (three are shown in FIG. 1) of the receptacle 102. The bathing unit system 100 further includes a circulation system 104 including a plurality of conduits 124 for removing water from and returning water to the receptacle 102 through the water inlets 120 and the water outlets 122. One skilled in the art will appreciate that practical implementations of the bathing unit system 100 may include additional or fewer water inlets 120, additional or fewer water outlets 122, a different configuration of conduits 124 in the circulation system 104 interconnecting the water inlets 120 and the water outlets 122 of the receptacle 102 etc.

### Bathing Unit Components

The bathing unit system 100 also includes a set of bathing unit components. In the embodiment shown in FIGS. 1 and 2, the set of bathing unit components includes at least one filter 108, at least one pump 106, at least one temperature change component 110 and at least one sensor 112, and a control system 118 in communication with these bathing unit components. In other embodiments, the bathing unit system 100 may include additional or alternative bathing unit components associated with the bathing unit system 100, such as at least one light for lighting the receptacle 102 and at least one speaker for projecting music or other audio data around the bathing unit system 100 for ambience.

The filter 108 may generally function to filter solids and other debris from the water 103. In the embodiment shown, the bathing unit system 100 includes only a single filter 108 positioned in the circulation system 104 before the other bathing unit components. In other embodiments, the bathing unit system 100 may include more than one filter 108, and may, e.g., include smaller filters associated with the with the at least one pump 106 and the at least one temperature change component 110.

### At Least One Pump 106

The at least one pump 106 may generally function to circulate the water 103 from the receptacle 102 through the water outlets 122, through the circulation system 104 and back into the receptacle 102 through the water inlets 120. In the embodiment shown, the at least one pump 106 includes a first pump 130, a second pump 132 and a third pump 134. In other embodiments, the bathing unit system 100 may include more additional or fewer pumps 106.

The first pump 130 may be a powered pump including a motor (not shown) which draws energy from a power source 116. In the embodiment shown, the first pump 130 comprises a variable speed pump and may be operate in, for example, a “low” mode where the motor of the first pump 130 draws a low amount of energy from the power source 116, a “standard” mode where the motor of the first pump 130 draws a standard amount of energy from the power source 116 and a “high” mode where the motor of the first pump 130 draws a high amount of energy from the power source 116. Alternatively, the first pump 130 may be a percentage modulated pump and the motor may operate anywhere between 0% and 100% of a maximum speed, and may correspondingly draw anywhere between 0% and 100% of a maximum amount of energy from the power source 116.

The second and third pumps 132 and 134 may also be powered pumps including respective motors (not shown) which draw energy from the power source 116. In the embodiment shown, the second and third pumps 132 and 134 may be a variable speed pump similar to the first pump 130, and may operate in, for example, a “low” mode, a “standard” mode and a “high” mode. In other embodiments, at least one of the second and third pumps 132 and 134 may instead comprise a single speed pump or a dual speed pump and, in operation, may only include a single “on” mode where the corresponding motor draws a fixed amount of energy from the power source 116 and an “off” mode where the corresponding motor draws no energy (or negligible energy) from the power source 116.

As will be described below, different combinations of the first, second and third pumps 130, 132 and 134 and different combination of operational modes thereof may be controlled by a controller 180 of the bathing unit system 100 to operate the bathing unit system 100 in various different operational modes and to cause the bathing unit system 100 to undergo different processes to determine or monitor thermal properties of the bathing unit system 100.

In some embodiments, in addition to circulating the water 103, the at least one pump 106 may also input thermal energy into the water 103 to raise a temperature of the water 103. For example, agitation of the water 103 by impellers of the at least one pump 106 as the water 103 is circulated by the at least one pump 106 may directly input thermal energy into the water 103. Additionally, referring to FIG. 2, the at least one pump 106 (e.g., the first pump 130) may be placed within an interior of the cabinet 101 of the particular bathing unit system 100. The interior of the cabinet 101 may be a closed and insulated (described below) space. As the motors of the at least one pump 106 operate to circulate the water 103, the motors may produce thermal energy which may be trapped in the interior of the cabinet 101 and which may raise the temperature of the interior of the cabinet 101. This thermal energy may be transferred through the receptacle 102 (e.g., via conduction) and into the water 103 in the receptacle 102, or may be transferred through the conduits 124 into the water 103 in the conduits 124 (e.g., again via conduction).

### At Least One Temperature Change Component 110

The at least one temperature change component 110 may generally function to change a temperature of the water 103 flowing through the circulation system 104 and within the receptacle 102 by inputting thermal energy or by removing thermal energy. In the embodiment shown, the at least one temperature change component 110 may include a primary heater 150 generally configured to heat the water 103, a primary cooler 152 generally configured to cool the water 103 and a combined auxiliary heater/cooler 154 generally configured to assist the primary heater 150 and the primary cooler to heat and cool the water 103 as applicable. In other embodiments, the bathing unit system 100 may include additional, fewer or alternative temperature change components 110.

The primary heater 150 may be an electrical heater including a heating element which draws energy from the power source 116. In the embodiment shown, the primary heater 150 may be operable in, for example, a “low” mode where the heating element draws a low amount of energy from the power source 116, a “standard” mode where the heating element draws a standard amount of energy from the power source 116 and a “high” mode where the primary heater 150 draws a high amount of energy from the power source 116. Alternatively, the primary heater 150 may be a percentage modulated heater, and the heating element may operate anywhere between 0% and 100% of a maximum heating capacity, and may draw anywhere between 0% and 100% of a maximum amount of energy from the power source 116.

The primary cooler 152 may be a thermoelectric cooling element which draws energy from the power source 116 to transfer heat from one surface of the primary cooler 152 (e.g., a cold surface) to another surface of the primary cooler 152 (e.g., a hot surface). Similar to the primary heater 150, the primary cooler 152 may be operable in, for example, a “low” mode where the cooling element draws a low amount of energy from the power source 116, a “standard” mode where the cooling element draws a standard amount of energy from the power source 116 and a “high” mode where the cooling element draws a high amount of energy from the power source 116. Alternatively, again similar to the primary heater 150, the primary cooler 152 may also have a percentage modulated operation.

The auxiliary heater/cooler 154 may be a heat transfer module such as a heat pump which draws energy from the power source 116 to transfer thermal energy from one area (e.g., cool area) to another area (e.g., hot area). Similar to the primary heater 150, the auxiliary heater/cooler 154 may also be operable in, for example, a “low” mode where the heat pump draws a low amount of energy from the power source 116, a “standard” mode where the heat pump draws a standard amount of energy from the power source 116 and a “high” mode where the heat pump draws a high amount of energy from the power source 116. Alternatively, again similar to the primary heater 150, the auxiliary heater/cooler 154 may also have a percentage modulated operation. Additionally, the auxiliary heater/cooler 154 may draw less energy from the power source 116 when compared to either the primary heater 150 or the primary cooler 152.

As will be described below, different combinations of the primary heater 150, the primary cooler 152 and the auxiliary heater/cooler 154 and different combinations of operational modes thereof may be controlled by the controller 180 of the bathing unit system 100 to operate the bathing unit system 100 in various different operational modes and to cause the bathing unit system 100 to undergo different processes to determine or monitor thermal properties of the bathing unit system 100.

### At Least One Sensor 112

The at least one sensor 112 may generally function to sense and/or measure a temperature of the water 103 within the receptacle 102, as well as an ambient temperature of the environment surrounding the bathing unit system 100.

In the embodiment shown, the at least one sensor 112 includes a receptacle temperature sensor 160 generally configured to sense a temperature of the water 103 within the receptacle 102, an inline temperature sensor 162 generally configured to sense a temperature of the water 103 before or after it passes through the at least one temperature change component 110, and an ambient temperature sensor 164 generally configured to sense an ambient temperature of the environment around the bathing unit system 100. In other embodiments, the at least one sensor 112 may include additional and/or alternative sensors which sense attributes of the water 103 within the bathing unit system different from water temperature, and may include, e.g., a depth sensor, a flow sensor, a pH sensor, an ORP sensor, a turbidity sensor, etc. In yet other embodiments, the at least one sensor may further include additional and/or alternative sensors which sense environmental factors other than ambient temperature, and may include e.g., a humidity sensor, a light sensor, the windspeed sensor, precipitation sensor, etc.

In operation, the at least one sensor 112 may also draw energy from the power source 116 to perform the sensing functionality of the at least one sensor 112. However, the energy drawn by the at least one sensor 112 may be negligible when compared to the energy drawn by the at least one pump 106 and the energy drawn by the at least one temperature change component 110.

### Control System 118

The bathing unit system 100 may also include the control system 118 in communication with the different bathing unit components including the at least one pump 106, the filter 108, the at least one temperature change component 110, the at least one sensor 112 and the at least one power source 116. In the embodiment shown, the control system 118 includes the controller 180 and a remote server 182. In other embodiments, the control system 118 may only include the controller 180 or may only include the remote server 182. Referring to FIGS. 1 and 2, the controller 180 may be located physically near (e.g., on or in a same room as) the bathing unit system 100. In contrast, the remote server 182 may be located physically separate (e.g., in a different building from) the bathing unit system 100. The controller 180 and/or the remote server 182 may generally be configured to receive parameters from the different bathing unit components noted above and to execute different processes to determine or monitor thermal properties of the bathing unit system 100. Additionally, the controller 180 may also be configured to transmit commands for controlling operation of the different bathing unit components, and may specifically control operation of the different bathing unit components based on the determined thermal properties of the bathing unit system 100 (e.g., a determined thermal property indicator of the bathing unit system 100). In some implementations, the controller 180 and the remote server 182 may collaborate with each other to implement different processes, or different parts of the processes, described in the present disclosure.

### Controller 180, Control Panel 198, User Device 184 and Power Source 116

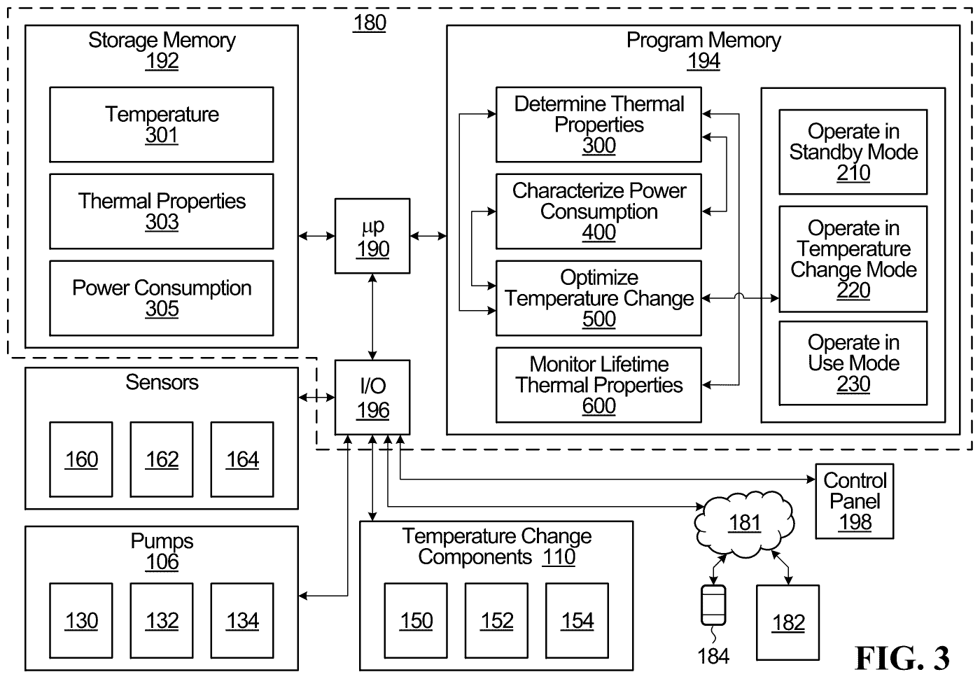

In the embodiment shown in FIG. 3, the controller 180 includes at least one local processor 190, a storage memory 192, a program memory 194 and a I/O interface 196, all in communication with the local processor 190. Other embodiments of the controller 180 may include fewer, additional or alternative components. Additionally, although only a single local processor 190, single storage memory 192, single program memory 194 and single I/O interface 196 is shown in FIG. 3, other embodiments of the controller 180 may include more than one of each of these components. For example, the controller 180 may include at least one first processor positioned topside of the receptacle 102 of the bathing unit system 100 configured to perform some of the functions of the controller 180 and at least one second processor positioned within the cabinet 101 of the bathing unit system 100 configured to perform other functions of the controller 180.

The I/O interface 196 includes an interface for the local processor 190 to communicate commands to, and receive information from, the bathing unit components of the bathing unit system 100, including the at least one pump 106, the at least one filter 108, the at least one temperature change component 110, the at least one sensor 112 and the at least one power source 116 for example. In the embodiment shown, the local processor 190 may communicate with these bathing unit components via a wired connection; in other embodiments, the local processor 190 may also communicate with the bathing unit components over a wireless network 181 (e.g., a wireless network such as a wifi or a cellular network). The I/O interface 196 may further include a communication module which generally enables the local processor 190 to (a) communicate with a remote processor 200 of the remote server 182 over the network 181, (b) a user device 184 associated with a user of the bathing unit system 100 over the network 181, (c) a control panel 198 of the bathing unit system 100 and (d) the at least one power source 116 as will be described below. The I/O interface 196 may include any communication interface which enables the local processor 190 to communicate with the bathing unit components and the remote server 182 as described above, including specialized or standard I/O interface technologies such as channel, port-mapped, asynchronous for example.

The I/O interface 196 may allow a user of the bathing unit system 100 to communicate commands to, and receive information from, the local processor 190, which may prompt the local processor 190 in turn to communicate with the bathing unit components, such as via the user device 184 or the control panel 198. The user device 184 may comprise, for example, a mobile phone, or a tablet, or a laptop, or a personal computer, etc. The user device 184 may include a processor for performing the operations of the user device 184 (e.g., by executing instructions stored in a program memory of the user device 184), a network interface (e.g., a transmitter/receiver with an antenna or a network interface card or a port) for communicating with the controller 180 and/or the remote server 182 and a user interface (e.g., keyboard, display, and/or touchscreen) for enabling user input and for displaying information regarding the different bathing unit components of the bathing unit system 100. The control panel 198 may comprise a topside control panel including keypads, touch screens and other actuators for enabling user input, as well as display screens for displaying information regarding the different bathing unit components of the bathing unit system 100. An example of such a topside control panel include various embodiments described in the related U.S. application Ser. No. 17/515,703, titled “TOPSIDE CONTROL PANEL AND TOPSIDE CONTROL PANEL SYSTEM FOR BATHING UNIT SYSTEM AND METHOD OF OPERATING THE SAME”, filed on Nov. 1, 2021 and related U.S. Pat. No. 10,353,499, titled “TOPSIDE CONTROL PANEL FOR BATHING UNIT SYSTEM”, filed on Mar. 19, 2018, the contents of which are incorporated by reference herein.

The I/O interface 196 may also enable the controller 180 to supply power from the at least one power source 116 to the different bathing unit components. For example, the at least one power source 116 may be operative to supply the controller 180 with any conventional power service suitable for residential or commercial use. For example, the at least one power source 116 may supply 240 volts (V) AC to the controller 180 via a service wiring 117 (shown in FIG. 1). In other embodiments, the at least one power source 116 may instead supply 120 V AC to the controller 180 via the service wiring 117. In yet other embodiments, the at least one power source 116 may supply 120 V and 240 V AC to the controller 180 via the service wiring 117. However, one skilled in the art will appreciate that other voltage supply values or voltage supply combinations are possible. For example, the voltage supply values may be different depending on geographical location. Additionally, other embodiments of the bathing unit system 100 may include other types of power sources 116, such as a stored electrical power source (e.g., battery), generated electrical power source (e.g., solar panel or wind/water turbine), a natural gas power source, an oil-based power source, etc. Further still, other embodiments of the bathing unit system 100 may include more than one power source 116, an individual power source 116 for each bathing unit component, or a power source 116 which is shared by more than one bathing unit component (but not by all bathing unit components) of a particular bathing unit system 100.

After receipt of the power from the at least one power source 116, the controller 180 may distribute the power to the different bathing unit components to operate the different bathing unit components in different operational modes or to cause the bathing unit system 100 to undergo different processes to determine and/or monitor thermal properties of the bathing unit system 100 as described below.

The storage memory 192 stores information received or generated by the local processor 190 and may generally function as an information or data store. In the embodiment shown, the storage memory 192 may include a temperature data store 301, a thermal properties data store 303, a consumption and output data store 305; in other embodiments, the storage memory 192 may include fewer, additional or alternative data stores. The program memory 194 stores various blocks of code (alternatively called processor-executable instructions and/or computer-executable instructions), for directing the local processor 190 to perform various processes, such as an operate in standby mode process 210, an operate in temperature change mode process 220, an operate in use mode process 230, a determine thermal properties process 300, a characterize power consumption and energy output process 400, an optimize temperature change process 500, and a monitor lifetime thermal properties process 600 as described below. The program memory 194 may also store database management system computer-executable instructions for managing the data stores in the storage memory 192. In other embodiments, the program memory 194 may store fewer, additional or alternative computer-executable instructions directing the local processor 190 to execute additional or alternative processes. The storage memory 192 and the program memory 194 may each be implemented as one or a combination of a non-transitory computer-readable medium and/or non-transitory machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching thereof). The expression “non-transitory computer-readable medium” or “non-transitory machine-readable medium” as used herein is defined to include any type of computer-readable storage device and/or storage disk and to exclude propagating signals and to exclude transmission media.

The local processor 190 is generally configured to execute instructions stored in the program memory 194 (including the determine thermal properties process 300, the characterize power consumption and energy output process 400, the optimize temperature change process 500, and the monitor lifetime thermal properties process 600 as described below), to retrieve information from, and store information into, the data stores (including the temperature data store 301, the thermal properties data store 303 and the consumption and output data store 305) of the storage memory 192, and to receive information and power from, and transmit commands and power to, the bathing unit system components (including the at least one pump 106, the filter 108, the at least one temperature change component 110, and the at least one sensor 112), the power source 116, the control panel 198, the user device 184, and/or the remote server 182 over the I/O interface 196.

### Remote Server 182

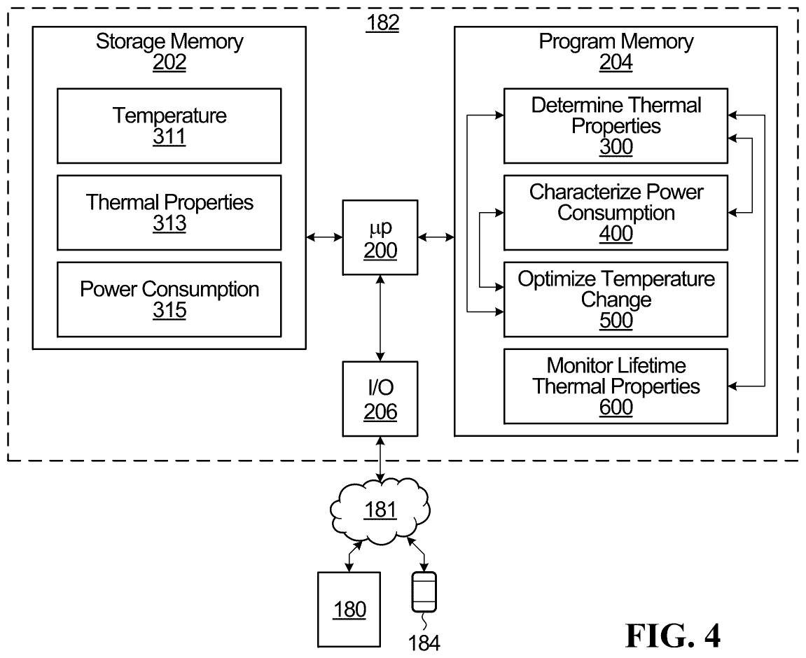

In the embodiment shown in FIG. 4, the remote server 182 includes at least one remote processor 200, a storage memory 202, a program memory 204 and a I/O interface 206, all in communication with the remote processor 200. Other embodiments of the remote server 182 may include fewer, additional or alternative components. Additionally, although only a single remote processor 200, single storage memory 202, single program memory 204 and single I/O interface 206 is shown in FIG. 4, other embodiments of the remote server 182 may include more than one of each of these components. For example, the remote server 182 may include at least one first remote server hosted at a first data center configured to perform some functions of the remote server 182 and at least one second remote processor server hosted at a second data center configured to perform some other functions of the remote server 182.

The I/O interface 206 includes an interface for the remote processor 200 to communicate commands to, and receive information from, the controller 180 via the network 181, and may specifically include an interface for the remote processor 200 to communicate commands to and receive information from (a) the local processor 190 of the controller 180 over the network 181 and (b) the user device 184 associated with a user of the bathing unit system 100 over the network 181. In some embodiments, the I/O interface 206 may also include an interface for the remote processor 200 to communicate directly with the bathing unit components (including the at least one pump 106, the filter 108, the at least one temperature change component 110, and the at least one sensor), the power source 116, and/or the control panel 198 via the network 181. Similar to the I/O interface 196 of the controller 180, the I/O interface 206 of the remote server 182 may include any communication interface which enables the remote processor 200 to communicate with the controller 180 and the user device 184, and optionally directly with the bathing unit components, the power source 116, and the control panel 198 including specialized or standard I/O interface technologies such as channel, port-mapped, asynchronous for example.

The storage memory 202 stores information received or generated by the remote processor 200 and may generally function as an information or data store. In the embodiment shown, the storage memory 202 may store a corresponding remote version of a temperature data store 311, a thermal properties data store 313, a consumption and output data store 315. In other embodiments, the storage memory 202 may include fewer, additional or alternative data stores. The program memory 204 stores various blocks of code (alternatively called processor-executable instructions and/or computer-executable instructions), for directing the remote processor 200 to perform various processes, such as the determine thermal properties process 300, the characterize power consumption and energy output process 400, the optimize temperature change process 500, and the monitor lifetime thermal properties process 600 as described below. The remote processor 200 of the remote server 182 may perform such various processes in addition to, as a redundancy for, or as an alternative to, the local processor 190 of the controller 180. In this regard, the remote processor 200 may have greater processing power and processing speed when compared to the local processor 190, and may perform certain steps of the various processes faster than the local processor 190. The program memory 204 may also store database management system computer-executable instructions for managing the data stores in the storage memory 202. In other embodiments, the program memory 204 may store fewer, additional or alternative computer-executable instructions directing the remote processor 200 to execute additional or alternative processes. The storage memory 202 and the program memory 204 may each be implemented as one or a combination of a non-transitory computer-readable medium and/or non-transitory machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching thereof).

The remote processor 200 is generally configured to execute instructions stored in the program memory 204 (including the determine thermal properties process 300, the characterize power consumption and energy output process 400, the optimize temperature change process 500, and the monitor lifetime thermal properties process 600 as described below), to retrieve information from, and store information into, the data stores (including the temperature data store 311, the thermal properties data store 313 and the energy consumption a store 315) of the storage memory 202, and to receive information from, and transmit commands to, the controller 180, the user device 184 and optionally the control panel 198 through the I/O interface 206.

### At Least One Insulating Component 114

Referring now to FIG. 2, as described above, the bathing unit system 100 includes at least one insulating component 114. The at least one insulating component 114 generally function to maintain thermal energy in the water 103 held in the receptacle 102. Accordingly, the thermal properties of a particular bathing unit system 100 and the thermal property indicators calculated for a particular bathing unit system 100 (e.g., thermal conductivity H of the particular bathing unit system 100, thermal resistance Θ of the particular bathing unit system 100, and/or k constant representative of a proportionality factor that relates to a rate of cooling or rate of heating of a particular bathing unit system 100) depend significantly on a quality and condition of the at least one insulating component 114 of the particular bathing unit system 100. In the embodiment shown, the at least one insulating component 114 include a cover 170, a covering seal 175, cabinet insulation 176 and receptacle insulation (not labelled). In other embodiments, the at least one insulating component 114 may include fewer, additional or alternative insulating components.

In the embodiment shown in FIG. 2, the cover 170 comprises a cover foam 171 encased in a covering 172 comprising a top surface 173 and a bottom surface (not show). The cover foam 171 may be made from polystyrene or expanded polystyrene (EPS). The covering 172 may be made from vinyl and may be water resistant; specifically, the top surface 173 may be a solid smooth surface while the bottom surface may have a mesh or grid structure to promote condensation of the water 103. An insulating capacity of the cover 170 may be proportional to (a) a material, density, and thickness of the cover foam 171, (b) a material of the covering 172, (c) a current condition of the cover foam 171 (e.g., whether the cover foam 171 is wet, frozen, etc.), and/or (d) a current condition of the covering 172 (e.g., whether the covering 172 has any cracks or tears). As the cover 170 functions to cover the opening of the receptacle 102 from which a majority of the thermal energy in the water 103 can escape, a large portion of the total insulative capacity of the at least one insulating component 114 is provided by the insulative capacity of the cover 170. Additionally, the different components of the cover 170 may be more likely to degrade than other insulating components, as the cover 170 is more exposed to the external environment and weather events at the top surface 173 and more exposed to humidity and condensation from the water 103 in the receptacle 102 at the bottom surface. As a result, the cover 170 is more likely to become damaged or otherwise lose insulating capacity (e.g., tears or other cracks in the covering 172 and absorption of water in the cover foam 171).

The covering seal 175 extends proximate the bottom surface around the perimeter of the cover 170. The covering seal 175 may function to seal around a perimeter of the receptacle 102 to further maintain the thermal energy inputted into the water 103 held in the receptacle 102 and to further prevent evaporation of the water 103. An insulating capacity of the cover 170 may further be proportional to an integrity of a seal formed by the covering seal 175, which may in turn be based on at least a relative dimension of a surface area of the cover 170 relative to a surface area of the receptacle 102 (e.g., whether the cover 170 covers the entirety of an opening of the receptacle 102) and a fit and condition of the covering seal 175.

In the embodiment shown in FIG. 2, the at least one insulating component 114 further includes cabinet insulation 176 placed around the receptacle 102 within the cabinet 101. The cabinet insulation 176 may comprise polyurethane foam. An insulation capacity of the cabinet insulation 176 may be proportional to at least (a) a material, density and thickness of the cabinet insulation 176, (b) a placement of the cabinet insulation 176 (e.g., placing the cabinet insulation 176 on a surface of the receptacle 102 and/or on a surface of the cabinet 101), (c) a material of the cabinet 101, (d) a condition of the cabinet insulation 176 (e.g., again whether the cabinet insulation 176 is wet, frozen, etc.), and (e) a condition of the cabinet 101 (e.g., whether the cabinet 101 is fully enclosed or has an cracks or openings).

Additionally, in some embodiments, the at least one insulating component 114 further includes a receptacle insulation formed by the receptacle 102 itself. An insulating capacity of the receptacle insulation may be proportional to at least (a) a material, density and thickness of the receptacle 102 and (b) a condition of the receptacle 102 (e.g., whether there are cracks in or worn-down portions of the receptacle 102).

One skilled in the art will appreciate that practical implementations of the bathing unit system 100 may include additional insulating components 114, such as a floating blanket to be placed on the water 103 within the receptacle 102, additional insulating layers to further encase the cover 170 and/or the lower portion of the receptacle 102, etc.

### Operating the Bathing Unit System in Different Operational Modes

The controller 180 may operate the bathing unit system 100 in a plurality of different operational modes including at least a standby mode by initiating the operate in standby mode process 210, a temperature change mode by initiating the operate in temperature change mode process 220 and a use mode by initiating the operate in use mode process 230.

### Operate in Standby Mode Process 210

During the standby mode, the bathing unit system 100 may not being used by a user and is also not being prepared for use by a user, and may be primarily operated by the controller 180 to filter the water 103, sanitize and otherwise maintain cleanliness of the water 103, prevent the water 103 from freezing in the conduits 124, etc. For example, the controller 180 may operate the at least one pump 106 (causing these components to draw power from the power source 116) to circulate the water 103 throughout the circulation system 104 for filtration thereof and to maintain flow through the conduits 124 using the operate bathing unit system in standby mode process 210 described below. During a lifetime of a typical bathing unit system 100, the bathing unit system 100 may be in standby mode more than 90% of the time.

In accordance with one embodiment, the operate in standby mode process 210 may include computer-executable instructions which direct the local processor 190 of the controller 180 to: (a) operate the first pump 130 in the “low” mode, the second pump 132 in the “on” mode, and the third pump 134 in the “off”′ mode for one minute, (b) operate the first pump 130 in the “low” mode, the second pump 132 in the “off” mode and the third pump 134 in the “on” mode for one minute, and (c) operate the first pump 130 in the “low” mode, the second pump 132 in the “off” mode, and the third pump 134 in the “off”′ mode for 58 minutes. The different steps (a), (b) and (c) of the operate in standby mode process 210 may be performed immediately sequentially (e.g., step (b) may be performed immediately after step (a)), or may be performed sequentially but with a delay in between (e.g., step (b) may be performed after a delay period after step (a)). The operate in standby mode process 210 may be executed at different times in a particular 24 hour period, and may repeat anywhere between 2-10 times a day and may specifically repeat 4 times a day.

Other embodiments of the operate in standby mode process 210 may include additional, alternative or fewer computer-executable instructions which direct the local processor 190 to control the at least one pump 106 to operate in a different operational mode than that described above, in a different sequence than that described above, for a different period than that described above, and/or at different times than that described above. More generally, the operate in standby mode process 210 may include any computer-executable instructions directing the local processor 190 to control the at least one pump 106 to circulate the water 103 through the circulation system 104 while the bathing unit system 100 is not in use and is not being prepared for use. For example, in other embodiments, the operate in standby mode process 210 may further direct the local processor 190 to also operate the at least one temperature change component 110 (causing these component to draw power from the initial power source 116) to counteract low (or high) ambient temperature sensed by ambient temperature sensor 164 and/or low (or high) current water temperature sensed by the receptacle temperature sensor 160. For example, some embodiments, the operate in standby mode process 210 may direct the local processor 190 to operate the primary heater 150 and/or the auxiliary heater/cooler 154 in the “on” mode when the local processor 190 receives temperature signals from the ambient temperature sensor 164 that ambient temperature is below 0° C. to prevent the water 103 from freezing within the circulation system 104. As an additional example, the operate in standby mode process 210 may direct the local processor 190 to operate the primary heater 150 and/or the auxiliary heater/cooler 154 in the “on” mode in when the local processor 190 receives temperature signals from receptacle temperature sensor 160 indicating that the water temperature of the water 103 held in the receptacle 102 has fallen below a threshold temperature to prevent the water 103 in the receptacle 102 from falling significantly below the threshold temperature. Maintaining the water 103 at the threshold temperature may reduce the amount of thermal energy and amount of time required to reach a desired bathing temperature for use by a user during the temperature change mode as described below.

### Operate in Temperature Change Mode Process 220

During temperature change mode, the bathing unit system 100 is being prepared for use by the user, and is primarily operated by the controller 180 to reach a target bathing temperature at a desired time for use by the user. For example, in temperature change mode, the control system 118 may operate the at least one pump 106 and the at least one temperature change component 110 (causing these components to draw power from the at least one power source 116) to heat the water 103 to a desired temperature at a desired time selected by the user or based on preferences of the user using the operate in temperature change mode process 220 described below. During a lifetime of a typical bathing unit system 100, operating the bathing unit system 100 in the temperature change mode may draw the most power from the power source 116 when compared to operating the bathing unit system 100 in the standby mode or the use mode (or any other mode).

In accordance with one embodiment, the operate in temperature change mode process 220 may include computer-executable instructions which direct the local processor 190 of the controller 180 to: (a) receive temperature signals from the receptacle temperature sensor 160 representing a current water temperature T_{wat1} of the water 103 held in the receptacle 102 and receive temperature signals from at least the ambient temperature sensor 164 representing a current ambient temperature T_{amb1} of the environment around the bathing unit system 100. (b) determine or receive the user a target bathing temperature T_{wat_final} of the water 103 and the receptacle 102 and/or a desired time point t_{final} at which the bathing unit system 100 is required to reach the target bathing temperature T_{wat_final}. (c) operate one or more of the at least one pump 106 and the at least one temperature change component 110 based on at least one retrieved extrinsic parameter and at least one calculated intrinsic parameter determined using the optimize temperature change process 500 to reach the target bathing temperature T_{wat_final} (e.g., received via temperature signals from the receptacle temperature sensor 160) at the desired time point t_{final}.

Other embodiments of the operate in temperature change mode process 220 may include additional, alternative or fewer computer-executable instructions which direct the local processor 190 to control one or more of the at least one pump 106 and the at least one temperature change component 110 to operate differently, in a different sequence, for different periods, or at different times. More generally, the operate in temperature change mode process 220 may include any computer-executable instructions for directing the local processor 190 to control one or more of the at least one pump 106 and the at least one temperature change component 110 to change a water temperature of the water 103 held in the receptacle 102 to prepare the bathing unit system 100 for use.

### Operate in Use Mode Process 230

During use mode, the bathing unit system 100 may be being used by the user and may be primarily operated by the controller 180 to provide the user with a desirable user experience. For example, the controller 180 may operate the at least one pump 106 to generate a desired water jet sequence at the water outlets 122 based on user input or otherwise based on preferences of the user, operate the at least one temperature change component 110 for maintaining the target bathing temperature T_{wat_final} of the water 103 while the user is within the water 103, and operate other components of the bathing unit components (such as at least one light and at least one speaker described above) to maintain a desired ambience during use of the bathing unit system 100 using the operate bathing unit system in use mode process 230 described below.

In accordance with one embodiment, the operate in use mode process 230 may include computer-executable instructions which direct the local processor 190 of the controller 180 to: (a) determine a desired water jet sequence of the water 103 and (b) operate the first pump 130 in the “high” mode, the second pump 132 in the “on” mode and the third pump 134 in the “on” mode to the produce the desired water jet sequence. Steps (a) and (b) of the operate in use mode process 230 may be performed repeatedly due to user input or otherwise based on user preference.

Other embodiments of the operate in use mode process 230 may include additional, alternative or fewer computer-executable instructions which direct the local processor 190 to control one or more of the at least one pump 106 or other bathing unit components of the bathing unit system 100 to operate in a different mode than that described above, in a different sequence, in different periods and at different times. More generally, the operate in use mode process 230 may include any suitable computer-executable instructions directing the local processor 190 to control one or more of the at least one pump 106 or other bathing unit components of the bathing unit system 100 while the bathing unit system 100 is being used. For example, in other embodiments, the operate in use mode process 230 may further include computer-executable instructions which direct the controller 180 to control the at least one temperature change component 110 to adjust the water temperature of the water 103 based on a current water temperature T_{wat1} of the water 103 (e.g., received via temperature signals from the receptacle temperature sensor 160) or a current ambient temperature T_{amb1} of the environment around the bathing unit system 100 (e.g., received via temperature signals from the ambient temperature sensor 164). Additionally, the operate in use mode process 230 may further include computer-executable instructions which direct the controller 180 to control other bathing unit components, such as the at least one light and the at least one speaker, to maintain an ambience around the bathing unit system 100 during use.

The control of the different bathing unit components of the bathing unit system 100 during each of the standby, temperature change and use modes as described above by the control system 118 may be modulated by the thermal property indicators of the bathing unit system 100 determined via the determine thermal properties process 300 described below, a change in the thermal properties of the bathing unit system 100 determined via the monitor lifetime thermal properties process 600 described below, a power consumption and energy output of the different bathing unit components (and in particular of the at least one pump 106 and the at least one temperature change component 110) and at least one retrieved input control or at least one calculated extrinsic parameters for controlling the bathing unit system 100 determined via the optimize temperature change process 500 described below.

### Determine Thermal Properties Process 300

While the controller 180 is operating the bathing unit system 100 in an operational mode (such as the standby mode, the temperature change mode and/or the use mode) the local processor 190 of the controller 180 and/or the remote processor 200 of the remote server 182 may initiate the determine thermal properties process 300. The determine thermal properties process 300 may include computer-executable instructions and other elements directing the local processor 190 and/or the remote processor 200 to derive a thermal property indicator for a bathing unit system 100 having a particular configuration of bathing unit components and a particular configuration of the at least one insulating component 114 (referred to hereinafter as a “particular bathing unit system”).

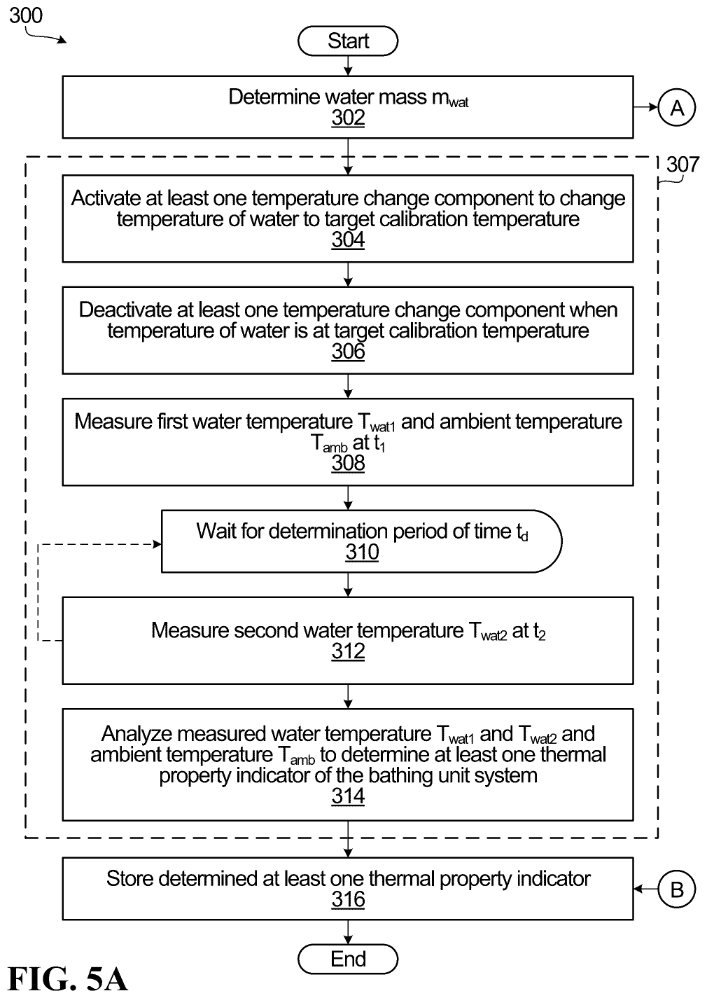

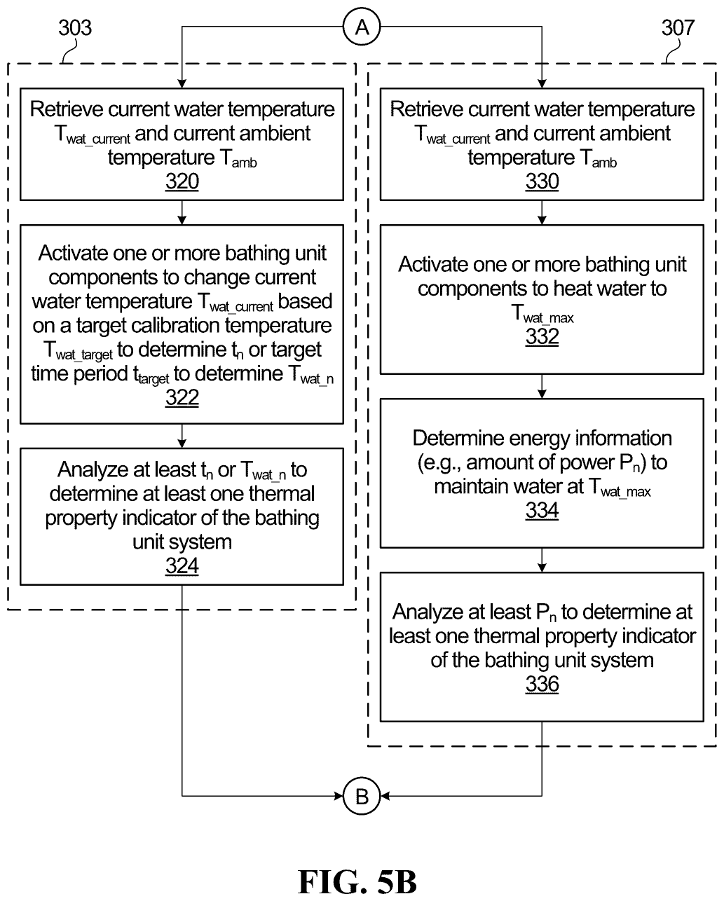

An embodiment of the determine thermal properties process 300 is shown in FIGS. 5A-5B. The determine thermal properties process 300 may be performed by a combination of the local and remote processors 190 and 200 executing processor-executable instructions and/or computer-executable instructions stored in the program memory 194 and 204 as applicable. In other embodiments, the determine thermal properties process 300 may comprise instructions stored on other types of non-transitory computer-readable storage medium, such as a CD-ROM, a floppy disk, a hard drive, a DVD, a Blu-ray disk or another component associated with the controller 180 or the remote server 182. In yet other embodiments, the determine thermal properties process 300 and/or parts thereof may be executed entirely by the local processor 190, executed entirely by the remote processor 200 and/or executed by a system other than the local and remote processors 190 and 200. Further, although the determine thermal properties process 300 in accordance with one embodiment is described with reference to the flowchart illustrated in FIGS. 5A and 5B, other methods of implementing the determine thermal properties process 300 may alternatively be used. For example, the order of execution of the blocks shown in FIG. 5 may be altered, and/or some of the blocks described may be altered, eliminated, or combined.

Referring to FIG. 5A, the determine thermal properties process 300 may begin at optional block 302, which may include computer-executable instructions directing the local processor 190 and/or the remote processor 200 to determine a mass of the water 103 within the receptacle 102 of a particular bathing unit system 100. For example, in some embodiments, block 302 (and the entire determine thermal properties process 300 in some embodiments) may be performed after the particular bathing unit system 100 has been installed at a field location associated with the user (e.g., a home of the user) and when the at least one sensor 112 includes the water depth sensor as described above. At the field location, receptacle dimensions (width, length and height) and a corresponding receptacle volume V_{rec} of the receptacle 102 may be known based on documentation or data provided by an original equipment manufacturer (OEM) of the receptacle 102. The receptacle dimensions and receptacle volume V_{rec} may be stored in the thermal properties data stores 303 or 313 of the storage memories 192 or 202. Based on the receptacle volume V_{rec} and the water depth signals received from the water depth sensor, a relative water volume V_{wat} of the water 103 within the receptacle 102 may be calculated based on a percentage fill of the receptacle 102 as shown in equation (1) below:

$$\% fill \times {V}_{r e c} \times E = {V}_{w a t} \qquad ( 1 )$$

whereby % fill is how much of the water 103 is within the receptacle 102 as calculated based on the water depth signals received from the water depth sensor; V_{rec} is the receptacle volume; E is a volume constant specific to the particular bathing unit system 100 used to account for a complex shape of the receptacle 102; and V_{wat} is the water volume.

The water volume V_{wat} may then be used to calculate water mass m_{wat} using equation (2) below:

$${ρ}_{w a t} = \frac{{m}_{w a t}}{{V}_{w a t}} \qquad ( 2 )$$

whereby β_{wat} is the water density of the water 103 within the receptacle 102 and which may be approximately 1 mg/L or may be a different density depending on any substances dissolved in the water 103 within the receptacle 102. For example, in some embodiments, the water density β_{wat} may be determined based on density signals received from a density sensor.

In other embodiments, such as embodiments where the at least one sensor 112 does not include the depth sensor, block 302 may direct the local processor 190 and/or the remote processor 200 to display or otherwise communicate a message to the user (e.g., via the control panel 198 and/or the user device 184) to prompt the user to estimate the % fill of equation (1) above. For example, in the embodiment shown in FIG. 1, the receptacle 102 includes different depth markings 140 with generally indicate a relative fill level of the water 103 in the receptacle 102. In the embodiment shown, the different depth markings 140 includes three different depth markings 140: (a) a 0% depth marking, (b) a 50% depth marking and (c) a 100% depth marking. A user may visually compare an approximate level of the water 103 within the receptacle 102 with the depth markings 140 to provide the estimate of the % fill. Block 302 may also direct the local processor 190 and/or the remote processor 200 to display or otherwise provide an input field (e.g., again via the control panel 198 and/or the user device 184) to prompt the user to enter the estimated % fill.

In yet other embodiments, block 302 (and the entire determine thermal properties process 300 in some embodiments) may be performed in a testing laboratory of the OEM of the particular bathing unit system 100 before installation at the field location. In the testing laboratory, the entire bathing unit system 100 and/or only the receptacle 102 may be placed on a scale, the water 103 may be added to the receptacle 102 and a water mass m_{wat} of the water 103 may be physically measured using the scale. Additionally or alternatively, in the testing laboratory, the receptacle 102 may be filled 100% with the water 103, such that V_{rec}=V_{wat}, and the water mass m_{wat} may be calculated using equation (2) above with this equivalence.

The determine thermal properties process 300 may then continue to block 307, which may include computer-executable instructions directing the local processor 190 and/or the remote processor 200 to derive the thermal property indicator for the particular bathing unit system at least in part by processing changes in the temperature of the water (e.g., in the receptacle 102 as measured by the receptacle temperature sensor 160 and/or in the circulation system 104 as measured by the inline temperature sensor 162) and/or deriving energy information corresponding to the bathing unit components (e.g., energy information corresponding to the at least one temperature change component 110 and/or the at least one pump 106).

Processing Rate of Cooling or Rate of Heating from a Target Water Temperature

For example, referring to FIG. 5A, in some embodiments, block 307 may include computer-executable instructions directing the local processor 190 and/or the remote processor 200 to derive the thermal property indicator by processing the changes in the temperature of the water according to sub-blocks 304, 306, 308, 310, 312 and 314. In such embodiments, block 307 may include sub-block 304, which may include computer-executable instructions directing the local processor 190 to activate the at least one temperature change component 110 (e.g., the primary heater 150, the primary cooler 152 and/or the auxiliary heater/cooler 154) to change a current water temperature T_{wat_current} of the water 103 in the receptacle 102 to a target calibration temperature T_{wat_target} in response to temperature signals from the receptacle temperature sensor 160 indicating that T_{wat_current}+T_{wat_target}. In the embodiment shown, the target calibration temperature T_{wat_target} may be set at a specific number of degrees above an ambient temperature T_{amb} of the environment around the bathing unit system 100 as sensed by the ambient temperature sensor 164 (e.g., +10° C., +15° C., +25° C., etc.), and sub-block 304 may include computer-executable instructions directing the local processor 190 to activate the primary heater 150 and/or the auxiliary heater/cooler 154 to heat the water 103 to the target calibration temperature T_{wat_target}. However, in other embodiments, the target calibration temperature may be set at a specific number of degrees below the ambient temperature T_{amb} of the environment (e.g., −5° C., −10° C., −15° C., etc.), and sub-block 304 may instead include computer-executable instructions directing the local processor 190 to activate the primary cooler 152 and/or the auxiliary heater/cooler 154 to cool the water 103 the target calibration temperature T_{wat_target}. In yet other embodiments, the target calibration temperature T_{wat_target} may be pre-set to a specific discrete temperature (e.g., 15° C., 20° C. 25° C., etc.), may selected by the user or based on preferences of the user indicating a commonly used temperature associated with the user (e.g., 35° C., 37.5° C., 40° C., etc.).

Block 307 may then continue to sub-block 306, which may include computer-executable instructions directing the local processor 190 to deactivate the at least one temperature change component 110 to cease changing the water temperature of the water 103 in response to temperature signals from the receptacle temperature sensor 160 indicating that the water 103 is at or around the target calibration temperature T_{wat_target}. For example, in embodiments where sub-block 304 directed the local processor 190 to activate the primary heater 150 to heat the water 103, sub-block 306 may include computer-executable instructions directing the local processor 190 to deactivate the primary heater 150. In contrast, in embodiments where sub-block 304 direct the local processor 190 to activate the primary cooler 152 to cool the water 103, sub-block 306 may instead include computer-executable instructions directing the local processor to deactivate the primary cooler 152.

Block 307 may then continue to sub-block 308, which may include computer-executable instructions directing the local processor 190 to retrieve (a) a first water temperature T_{wat1} of the water 103 in the receptacle 102 using the receptacle temperature sensor 160 (wherein T_{wat1}≈T_{wat_current}). (b) retrieve a ambient temperature T_{amb} of the environment around the bathing unit system 100 using the ambient temperature sensor 164 and (c) retrieve a first time point t₁ using a clock associated with the local processor 190. The first water temperature T_{wat1}, the ambient temperature T_{amb}, and the first time point t₁ may be locally stored in the temperature data store 301 of the storage memory 192 of the controller 180 and/or may also be transmitted to the remote server 182 by the controller 180 and may also be remotely stored in the temperature data store 311 of the storage memory 202 of the remote server 182.

Block 307 may then continue to sub-block 310, which may include computer-executable instructions directing the local processor 190 to wait for a determination time period of time t_{d}. In the embodiment shown, the determination time period t_{d} is pre-set to a discrete amount of time (e.g., 30 seconds, 10 minutes, 30 minutes, etc.). However, in other embodiments, the determination time period t_{d} may be varied based on a difference between the first water temperature T_{wat1} and the first ambient temperature T_{amb1} (e.g., 10 minutes if the difference is >15° C., 20 minutes if the difference between <15° C. but≥5° C., 30 minutes if the difference is <5° C.), etc.

Block 307 may then continue to sub-block 312, which may include computer-executable instructions directing the local processor 190 to retrieve (a) a second water temperature T_{wat2} of the water 103 in the receptacle 102 using the receptacle temperature sensor 160, and (b) retrieve a second time point t₂ (wherein t₂=t₁+t_{d}) using the clock. In some embodiments, the ambient temperature T_{amb1} may be a first ambient temperature and sub-block 312 may also direct the local processor 190 retrieve a second ambient temperature T_{amb2} of the environment using the ambient temperature sensor 164 at the second time point t₂; however, in the embodiment described below, some of the equations for deriving a thermal property indicator assume that the ambient temperature of the environment stays constant as between the first time point t₁ and the second time point t₂. Similar to sub-block 308 above, the second water temperature T_{wat2} and the second time point t₂ (and optionally the second ambient temperature T_{amb2}) may be locally stored in the temperature data store 301 and/or may also be transmitted to the remote server 182 and may be remotely stored in the corresponding temperature data store 311 of the remote server 182.

In certain embodiments, block 307 may repeat sub-blocks 310 and 312 several times to obtain additional water temperatures and time points (and optionally additional ambient temperatures). For example, sub-blocks 310 and 312 may be repeated three times to retrieve and store third, fourth and fifth water temperatures and time points (e.g., T_{wat3}, T_{wat4}, T_{wat5}, t₃, t₄ and t₅; and optionally third, fourth, fifth ambient temperatures T_{amb3}, T_{amb4}, T_{amb5}). In other embodiments, sub-blocks 310 and 312 may not be repeated, or may be repeated a fewer or a greater number of times.

Block 307 may then continue to sub-block 314, which may include computer-executable instructions directing the local processor 190 and/or the remote processor 200 to analyze the obtained water temperatures (at least first and second water temperatures T_{wat} and T_{wat2}), the obtained ambient temperature (at least ambient temperature T_{amb}) and the obtained time points (at least first and second time points t₁ and t₂) to derive a rate of change of the temperature of the water temperature T_{wat}, which may in turn be used as (or to derive) at least one thermal property indicator for the particular bathing unit system 100. As described above and below, thermal property indicators for a particular bathing unit system 100 (e.g., thermal conductivity H of the particular bathing unit system 100, thermal resistance Θ of the particular bathing unit system 100, and/or k constant representative of a proportionality factor that relates to a rate of cooling or rate of heating of a particular bathing unit system 100) may depend significantly on a quality and condition of the at least one insulating component 114 of the particular bathing unit system 100. For example, approximately 50% of insulation of a particular bathing unit system 100 may be attributed to the cover 170 of the particular bathing unit system 100 while approximately 30% of the insulation may be attributed to the cabinet insulation 176 of the particular bathing unit system 100. Accordingly, the at least one thermal property indicator derived at sub-block 314 may be used to convey a current condition of the at least one insulating component 114.

In embodiments where the water temperature T_{wat} at a particular time (e.g., the first water temperature T_{wat1}) is greater than the ambient temperature T_{amb}), sub-block 314 may direct the local processor 190 and/or the remote processor 200 to determine the thermal property indicator for the particular bathing unit system 100 using equations (3)-(10) below. For example, sub-block 314 may direct the local processor 190 and/or the remote processor 200 to determine a k constant representative of a proportionality factor that relates to a rate of cooling (e.g., in situations where T_{wat} is greater than T_{amb}, the water 103 in the receptacle 102 will lose heat to the environment around the bathing unit system 100) using equation (3) below, which may be simplified into equation (4) below. Equations (3) and (4) is generally representative of Newton's law of cooling, which provides that a rate of heat loss of a body (e.g., water 103 in the receptacle 102) is directly proportional to the difference in temperatures between the body (e.g., T_{wat}) and its environment (e.g., T_{amb}).

$$- \frac{d {T}_{w a t}}{d t} = k ( {T}_{w a t} - {T}_{a m b} ) \qquad ( 3 )$$

$$\frac{d {T}_{w a t}}{d t} = - k ( {T}_{w a t} - {T}_{a m b} ) \qquad ( 4 )$$

whereby the k constant is representative of a proportionality factor that relates a rate of cooling of the particular bathing unit system 100 and may depend on the water mass m_{wat} and thermal characteristics (specifically, a thermal conductivity H and a correlating thermal resistance Θ) of the particular bathing unit system 100 and has units of 1/s:

$$\frac{d {T}_{w a t}}{d t}$$

is a differential operator proportional to the k constant and a difference between T_{wat} and T_{amb}: whereby dT_{wat} is a change in water temperature of the water 103 within the receptacle 102 and has units of ° C.; dt is an infinitesimal period of time and has units of s; T_{wat} is a water temperature of the water 103 within the receptacle 102 and has units of ° C.; and T_{amb} is an ambient temperature of the environment around the particular bathing unit system 100 and also has units of ° C.

Again, in situations where the T_{wat} at a particular time (e.g., the first water temperature T_{wat1}) is greater than the ambient temperature T_{amb}, equation (4) may be integrated to arrive at equation (5) below:

$${T}_{w a t} ( t ) = A {e}^{- k t} + {T}_{a m b} \qquad ( 5 )$$

whereby the A constant of the particular bathing unit system 100; T_{wat} (t) is the water temperature of the water 103 within the receptacle 102 at any point in time; and T_{amb} is the ambient temperature of the environment around the particular bathing unit system 100 and may be constant due to integration of equation (4).

To determine A, it can first be assumed that t is equivalent to the first time point t₁ (such that T_{wat} (t)=T_{wat1} and that T_{amb} remains constant as per above to simplify equation (5) above into equation (6) below:

$${T}_{w a t 1} = A {e}^{- k \cdot ( {t}_{1} )} + {T}_{a m b} \qquad ( 6 )$$

Thereafter, it can further be assumed that t₁=0, equation (6) can be further simplified into equation (7) below to solve for A:

$$A = {T}_{w a t 1} - {T}_{a m b} \qquad ( 7 )$$

whereby, when t₁=0, A is substantially a differential temperature between the first water temperature T_{wat1} and the ambient temperature T_{amb} when the at least one temperature change component 110 is deactivated at sub-block 306.

To isolate the k constant, equation (5) above may be reorganized into equation (8) below, which may be integrated and reorganized into equation (9) below:

$${e}^{- k t} = \frac{{T}_{w a t} ( t ) - {T}_{a m b}}{A} \qquad ( 8 )$$

$$k = - \frac{1}{t} ln ( \frac{{T}_{w a t} ( t ) - {T}_{a m b}}{A} ) \qquad ( 9 )$$

Thereafter, it can further be assumed that when t is equivalent to the second time point t₂ (such that T_{wat} (t)=T_{wat2} and that T_{amb} remains constant as per above) and A=T_{wat1}-T_{amb} as determined using equation (7) above, equation (9) can be transformed into equation (10) below to solve for the k constant using the obtained water temperatures (e.g., at least first and second water temperatures T_{wat1} and T_{wat2}), the obtained time points (e.g., at least first and second time points t₁ and t₂) and the constant ambient temperature (e.g., T_{amb}) generated at sub-block 308 and 312 of the determine thermal properties process 300:

$$k = - \frac{1}{{t}_{2}} ln ( \frac{{T}_{wat 2} - {T}_{a m b}}{{T}_{w a t 1} - {T}_{a m b}} ) \qquad ( 10 )$$

One of ordinary skill in the art would recognize that the logic used to transform equation (9) into equation (10) may be used for any arbitrary time point (e.g., t₃, t₄, t₅, t_{arb}) and any arbitrary temperature of water at that arbitrary time point (e.g., T_{wat3}, T_{wat4}, T_{wat5} and T_{wat_arb}). More specifically, equation (9) may be transformed into equation (10.1) below:

$$k = - \frac{1}{{t}_{arb}} ln ( \frac{{T}_{wat \_ arb} - {T}_{amb}}{{T}_{wat 1} - {T}_{amb}} ) \qquad ( 10.1 )$$

In contrast, in embodiments where the water temperature T_{wat} at a particular time (e.g., the first water temperature T_{wat1}) is less than the ambient temperature T_{amb}, sub-block 314 may direct the local processor 190 and/or the remote processor 200 to determine the thermal property indicator for the particular bathing unit system 100 using equations (11)-(17) below. For example, sub-block 314 may direct the local processor 190 and/or the remote processor 200 to determine a k constant representative of a proportionality factor that relates to a rate of heating (e.g., in situations where T_{wat} is less than T_{amb}, the water 103 in the receptacle 102 will gain heat to the environment around the bathing unit system 100) using equation (11) below.

$$\frac{{dT}_{wat}}{dt} = - k ( {T}_{amb} - {T}_{wat} ) \qquad ( 11 )$$

Again, in situations where the T_{wat} at a particular time (e.g., the first water temperature T_{wat1}) is less than the ambient temperature T_{amb}, equation (11) may be integrated to arrive at equation (12) below:

$${T}_{wat} ( t ) = {T}_{amb} - A {e}^{- kt} \qquad ( 12 )$$

whereby the A constant of the particular bathing unit system 100; T_{wat} (t) is the water temperature of the water 103 within the receptacle 102 at any point in time; and T_{amb} is the ambient temperature of the environment around the particular bathing unit system 100 and may be constant due to integration of equation (11).

To determine A, it can first be assumed that t is equivalent to the first time point t₁ (such that T_{wat} (t)=T_{wat1} and that T_{amb} remains constant per above) to simplify equation (12) above into equation (13) below:

$${T}_{wat 1} = {T}_{amb} - A {e}^{- k \cdot ( {t}_{1} )} \qquad ( 13 )$$

Thereafter, it can further be assumed that t₁=0, equation (13) can be further simplified into equation (14) below to solve for A:

$$A = {T}_{amb} - {T}_{wat 1} \qquad ( 14 )$$

whereby, when t₁=0, A is substantially a differential temperature between the ambient temperature T_{amb} and the first water temperature T_{wat1} when the at least one temperature change component 110 is deactivated at sub-block 306.

To isolate the k constant, equation (13) above may be reorganized into equation (15) below, which may be integrated and reorganized into equation (16) below:

$${e}^{- k t} = \frac{{T}_{amb} - {T}_{wat} ( t )}{A} \qquad ( 15 )$$

$$k = - \frac{1}{t} ln ( \frac{{T}_{amb} - {T}_{wat} ( t )}{A} ) \qquad ( 16 )$$

Thereafter, it can further be assumed that t when is equivalent to the second time point t₂ (such that T_{wat} (t)=T_{wat2} and that T_{amb} remains constant as per above) and A=T_{amb}-T_{wat1} as determined using equation (14) above, equation (16) can be transformed into equation (17) below to solve for the k constant using the obtained water temperatures (e.g., at least first and second water temperatures T_{wat1} and T_{wat2}), the obtained time points (e.g., at least first and second time points t₁ and t₂) and the and the constant ambient temperature (e.g., T_{amb}) generated at sub-blocks 308 and 312 of the determine thermal properties process 300:

$$k = - \frac{1}{{t}_{2}} ln ( \frac{{T}_{amb} - {T}_{wat 2}}{{T}_{amb} - {T}_{wat 1}} ) \qquad ( 17 )$$

One of ordinary skill in the art would recognize that the logic used to transform equation (16) into equation (17) may be used for any arbitrary time point (e.g., t₃, t₄, t₅, t_{arb}) and any arbitrary temperature of water at that arbitrary time point (e.g., T_{wat3}, T_{wat4}, Twats and T_{wat}_arb). More specifically, equation (16) may be transformed into equation (17.1) below:

$$k = - \frac{1}{{t}_{arb}} ln ( \frac{{T}_{amb} - {T}_{wat \_ arb}}{{T}_{amb} - {T}_{wat 1}} ) \qquad ( 17.1 )$$

After determining the k constant, sub-block 314 may further direct the local processor 190 and/or the remote processor 200 to determine additional or alternative thermal property indicators (specifically a thermal conductivity H and a correlating thermal resistance O) of the particular bathing unit system 100 using equations (18)-(21) below.

As described above, the k constant is representative of a proportionality factor that relates to a rate of cooling of a particular bathing unit system 100 (e.g., in situations where the water temperature T_{wat} (t) is greater than the constant ambient temperature T_{amb}) or a rate of heating of the particular bathing unit system 100 (e.g., in situations where the water temperature T_{wat} (t) is less than the constant ambient temperature T_{amb}), the k constant may be used to determine a system time constant t of the bathing unit system 100 using equation (18) below:

$$τ = \frac{1}{k} \qquad ( 18 )$$

whereby t is a system time constant representative of a response of a particular bathing unit system 100 to an input of thermal energy (e.g., using one or more of the at least one pump 106 and the at least one temperature change component 110), assuming that the change in thermal energy of the particular bathing unit system 100 due to the ambient temperature of the environment surrounding the bathing unit system 100 is a linear and time-invariant.

The particular bathing unit system 100 may be modeled as the linear and time-invariant thermal system and using the time constant T via equation (19) below:

$$τ = \frac{{m}_{wat} {C}_{p}}{H} \qquad ( 19 )$$

whereby m_{wat} is the water mass of the water 103 in the receptacle 102 in units of kg (e.g., determined at block 302 of the determine thermal properties process 300): Cₚ is heat capacity of water which is approximately

$$4180 \frac{J}{kg ° C .} ;$$

and H is the thermal conductivity of the bathing unit system 100 in units of

$$\frac{J}{s ° C .} or \frac{W}{° C .} .$$

Combining equation (19) with equation (18) to generate equation (20) below, which allows the thermal conductivity H of the particular bathing unit system 100 to be solved using the water mass m_{wat} of the water 103 in the receptacle 102 and the determined k constant:

H=km_{wat}Cₚ (20)

The thermal conductivity H of the particular bathing unit system 100 can then be used to calculate the thermal resistance Θ of the particular bathing unit system 100 using equation (21) below:

$$Θ = \frac{1}{H} \qquad ( 21 )$$

### Processing Rate of Heating or Rate of Cooling to a Target Water Temperature

Now referring to FIG. 5B, in other embodiments, block 307 may include computer-executable instructions directing the local processor 190 and/or the remote processor 200 to derive the thermal property indicator by processing the changes in the temperature of the water according to sub-blocks 320, 322 and 324 instead. In such embodiments, block 307 may instead include sub-block 320, which may include computer-executable instructions directing the local processor 190 and/or the remote processor 200 to retrieve a current water temperature T_{wat_current} of the water 103 (e.g., from the receptacle temperature sensor 160 and/or the inline temperature sensor 162) and to retrieve a current ambient temperature T_{amb} of the environment around the bathing unit system 100 (e.g., from the ambient temperature sensor 164). The equations for deriving a thermal property indicator below assume that the ambient temperature T_{amb} stays constant over a period of time (e.g., over the resulting period of time ty or over the target period of time t_{target} as described below). However, one of ordinary skill in the art will appreciate that it is possible to derive equations which account for changes in the ambient temperature over the period of time in some embodiments.

Block 307 may then proceed to sub-block 322, which may include computer-executable instructions directing (a) the local processor 190 to activate one or more of the bathing unit components (e.g., the at least one temperature change component 110 and/or the at least one pump 106) to change a current water temperature T_{wat_current} of the water 103 and (b) the local processor 190 and/or the remote processor 200 to determine a capacity of such one or more of the bathing unit components to change the current water temperature T_{wat_current} based on the ambient temperature T_{amb}.

For example, in certain embodiments, sub-block 322 may involve a target calibration temperature T_{wat_target}. In such embodiments, sub-block 322 may (a) direct the local processor 190 activate one or more of the bathing unit components (e.g., the at least one temperature change component 110 and/or the at least one pump 106) to heat the water 103 to the target calibration temperature T_{wat_target} and (b) direct the local processor 190 and/or the remote processor 200 to determine a resulting period of time tₙ it takes for the current water temperature T_{wat_current} of the water 103 to reach the target calibration temperature T_{wat_target} for a given ambient temperature T_{amb} and based on a current operational mode of the bathing unit components. As a more specific example, sub-block 322 may determine the resulting period of time tₙ based on T_{wat_target} of approximately 40° C., T_{amb} of approximately 25° C., when the primary heater 150 and the first pump 130 are operated in the “high” mode, and when the primary cooler 152, the auxiliary heater/cooler 154, the second pump 132 and the third pump 134 are in the “off”′ mode.

Block 307 may then proceed to sub-block 324, which may include computer-executable instructions directing the local processor 190 and/or the remote processor 200 to derive the thermal property indicator for the particular bathing unit system 100 based on the tₙ and T_{wat_target} determined at sub-block 322. As a specific example, in embodiments where the k constant representative of a proportionality factor that relates to a rate of cooling (e.g., in situations where T_{wat_current} is greater than T_{amb}, the water 103 in the receptacle 102 will lose heat to the environment around the bathing unit system 100), equation (9) above may be rewritten as equation (9.1) below and equation (10) above may be rewritten as equation (10.2) below:

$$k = - \frac{1}{{t}_{n}} ln ( \frac{{T}_{{wat}_{-} target - {T}_{amb}}}{A} ) \qquad ( 9.1 )$$

$$k = - \frac{1}{{t}_{n}} ln ( \frac{{T}_{{wat}_{-} target - {T}_{amb}}}{{T}_{{wat}_{-} current} - {T}_{amb}} ) \qquad ( 10.2 )$$

whereby T_{wat_current} is the starting water temperature; T_{wat_target} is the target calibration temperature; t is the resulting period of time it takes to reach the target calibration temperature T_{wat_target} from T_{wat_current} as determined by sub-block 324; and T_{amb} is the constant ambient temperature.

The k constant determined using equation (9.1) above may then be used to determine the τ of a system (equation (18)), H (equations (19) and (20)) and O (equation (21)) as described above.

In other embodiments, sub-block 322 may instead involve a target period of time t_{target}. In such embodiments, sub-block 322 may (a) direct the local processor 190 to activate one or more of the bathing unit components (e.g., the at least one temperature change component 110 and/or the at least one pump 106) in a particular operational mode to heat the water 103 for the target period of time t_{target} and (b) direct the local processor 190 and/or the remote processor 200 to determine a resulting water temperature T_{wat_n} of the water 103 after the target period of time t_{target} for a given ambient temperature T_{amb} and based on the current operational mode of the bathing unit components. As a more specific example, sub-block 322 may determine resulting water temperature T_{wat_n} based on t_{target} of approximately 60 minutes, T_{amb} of approximately 25° C., when the primary heater 150 and the first pump 130 are operated in the “high” mode, and when the primary cooler 152, the auxiliary heater/cooler 154, the second pump 132 and the third pump 134 are in the “off” mode.

In such embodiments, sub-block 324 may instead include computer-executable instructions directing the local processor 190 and/or the remote processor 200 to derive the thermal property indicator for the particular bathing unit system 100 based on t_{target} and T_{wat_n} determined at sub-block 322. As a specific example, in embodiments where the k constant representative of a proportionality factor that relates to a rate of cooling (e.g., in situations where T_{wat_current} is greater than T_{amb}, the water 103 in the receptacle 102 will lose heat to the environment around the bathing unit system 100), equation (9) above may be rewritten as equation (9.2) below and equation (10) above may be rewritten as equation (10.3) below:

$$k = - \frac{1}{{t}_{target}} ln ( \frac{{T}_{wat \_ n} - {T}_{amb}}{A} ) \qquad ( 9.1 )$$

$$k = - \frac{1}{{t}_{target}} ln ( \frac{{T}_{wat \_ n} - {T}_{amb}}{{T}_{{wat}_{-} current} - {T}_{amb}} ) \qquad ( 10.2 )$$

whereby T_{wat_current} is the starting water temperature; t_{target} is the target period of time; T_{wat_n} is the water temperature after the target period of time t_{target} as determined by sub-block 324; and T_{amb} is the constant ambient temperature.

The k constant determined using equation (9.1) above may then be used to determine the τ of a system (equation (18)), H (equations (19) and (20)) and Θ (equation (21)) as described above.

### Processing Amount of Power or Amount of Thermal Energy to Maintain a Target Water Temperature

Still referring to FIG. 5B, in other embodiments, block 307 may instead include computer-executable instructions directing the local processor 190 and/or the remote processor 200 to derive the thermal property indicator by deriving energy information corresponding to one or more of the bathing unit components according to sub-blocks 330, 332, 334 and 336. In such embodiments, block 307 may include sub-block 330, which may include computer-executable instructions directing the local processor 190 and/or the remote processor 200 to retrieve a current water temperature T_{wat_current} of the water 103 (e.g., using the receptacle temperature sensor 160 and/or the inline temperature sensor 162) and retrieve a current ambient temperature T_{amb} of the environment around the bathing unit system 100 (e.g., using the ambient temperature sensor 164). In the embodiments described below, the T_{wat_current}=T_{amb}. Additionally, the equations for deriving a thermal property indicator below assume that the ambient temperature T_{amb} of the environment stays constant over a period of time during which energy or power is inputted into the water 103. However, one of ordinary skill in the art will appreciate that it is possible to derive equations which account for changes in the ambient temperature over the period of time in some embodiments and equations which derive a thermal property indicator based when T_{wat_current} #T_{amb}.

Block 307 may then proceed to sub-block 332, which may include computer-executable instructions which direct the local processor 190 to heat the water 103 until the temperature of the water 103 reaches a maximum water temperature T_{wat_max} which can be reached by the water 103 due to a known rate of thermal energy inputted Pᵢₙ. For example, sub-block 332 may direct the local processor 190 to activate one or more of the at least one temperature change component 110 (e.g., the primary heater 150, the primary cooler 152 and/or the auxiliary heater/cooler 154) and the at least one pump 106 (e.g., the first pump 130, the second pump 132 and/or the third pump 134) until a temperature of the water 103 does not increase any further (e.g., T_{wat}=T_{wat_max}) based on temperature measurements of the water 103 received from the at least one sensor 112 (e.g., the receptacle temperature sensor 160 and/or the inline temperature sensor 162). Generally, when the maximum temperature T_{wat_max} of the water 103 is reached for a given Pᵢₙ, it means that the thermal equilibrium water temperature T_{wat_equit} for that Pᵢₙ has also been reached, whereby the amount of power inputted Pᵢₙ into water 103 in the receptacle 102 has the same value as the amount of power outputted Pₒᵤₜ towards environment around the bating unit system 100.

Block 307 may then proceed to sub-block 334, which may include computer-executable instructions directing the local processor 190 and/or the remote processor 200 to determine energy information corresponding to one or more of the bathing unit components in order to maintain the water 103 at the at the maximum water temperature T_{wat_max} given the ambient temperature T_{amb}. For example, in some embodiments, sub-block 334 may direct the local processor 190 and/or the remote processor 200 to determine an amount of power Pₙ inputted by one or more of the bathing unit components into the water 103 in order to maintain the water 103 at the at the maximum water temperature T_{wat_max} given the ambient temperature T_{amb}. The amount of power Pₙ inputted by a particular bathing unit component may be retrieved using a power consumption model corresponding to that particular bathing unit component (e.g., based on the power consumption models for the at least one temperature change component 110 generated at block 402, and/or the power consumption models for the at least one pump 106 generated at block 406, both blocks 402 and 406 of the characterize power consumption and energy output process 400 described below).

Block 307 may then proceed to sub-block 336, which may include computer-executable instructions directing the local processor 190 and/or the remote processor 200 to derive the thermal property indicator for the particular bathing unit system 100 based on the Pₙ determined at sub-block 334. As one example, similar to equations (26) and (28) described below, when the water 103 is at T_{wat_max}=T_{wat_equil}, the known rate of thermal energy inputted Pₙ can be used to determine both thermal resistance Θ and thermal conductivity H as per equations (26.1) and (28.1) below:

$${T}_{wat \_ max} = ( {P}_{n} \times θ ) + {T}_{a m b} \qquad ( 26.1 )$$

$${T}_{wat \_ max} = \frac{{P}_{n}}{H} + {T}_{a m b} \qquad ( 28.1 )$$

whereby T_{wat_max} is the maximum water temperature for a given ambient temperature T_{amb} and a given an amount of power inputted Pₙ by the one or more bathing unit components into the water 103; Pₙ is the amount of power inputted by the one or more bathing unit components as determined at sub-block 334; and T_{amb} is the constant ambient temperature as determined at sub-block 330.

Equation (28.1) can then be rearranged into equation (28.2) below to determine H.

$$H = \frac{{P}_{n}}{{T}_{wat \_ max} - {T}_{amb}} \qquad ( 28.2 )$$

The determine thermal properties process 300 may then continue to block 316, which may include computer-executable codes directing the local processor 190 and/or the remote processor 200 to store the determined thermal property indicator (e.g., including at least the k constant representative of a proportionality factor that relates to a rate of cooling or a rate of heating of a particular bathing unit system 100, the thermal conductivity H of a particular bathing unit system 100, and the thermal resistance Θ of the particular bathing unit system 100) in the thermal properties data store 303 of the storage memory 192 and/or the thermal properties data store 313 of the storage memory 202. The determine thermal properties process 300 may then end.

### Characterize Power Consumption and Energy Output Process 400

Additionally, while the controller 180 is operating the bathing unit system 100 in an operational mode (such as the standby mode, the temperature change mode and/or the use mode) the local processor 190 of the controller 180 and/or the remote processor 200 of the remote server 182 may initiate the characterize power consumption and energy output process 400. The characterize power consumption and energy output process 400 may include computer-executable instructions directing the local processor 190 and/or the remote processor 200 to determine power consumption of the bathing unit components of the particular bathing unit system 100 (e.g., one or more of the at least one pump 106 and the at least one temperature change component 110) during the different operational modes and to determine thermal energy outputted by the bathing unit components of the particular bathing unit system 100 (again including one or more of the at least one pump 106 and the at least one temperature change component 110) at determine thermal properties process 300.

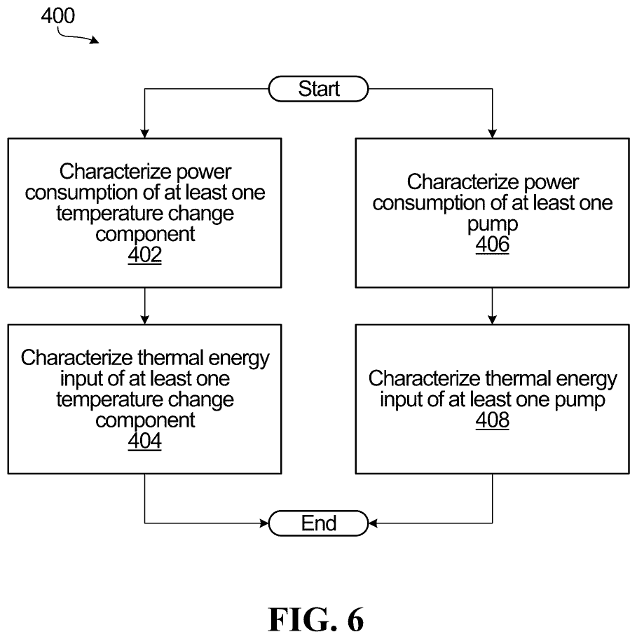

An embodiment of the characterize power consumption and energy output process 400 is shown in FIG. 6. In some embodiments, the characterize power consumption and energy output process 400 may be performed by a combination of the local and remote processors 190 and 200 executing processor-readable instructions and/or computer-readable instructions stored in the program memory 194 and 204 as applicable. In other embodiments, the characterize power consumption and energy output process 400 may comprise instructions stored on other types of non-transitory computer-readable storage medium. In yet other embodiments, the characterize power consumption and energy output process 400 and/or parts thereof may be executed entirely by the local processor 190, executed entirely by the remote processor 200 and/or executed by a system other than the local and remote processors 190 and 200. Further, although the characterize power consumption and energy output process 400 in accordance with one embodiment is described with reference to the flowchart illustrated in FIG. 6, other methods of implementing the characterize power consumption and energy output process 400 may alternatively be used. For example, the order of execution of the blocks shown in FIG. 6 may be altered, and/or some of the blocks described may be altered, eliminated, or combined.

Referring to FIG. 6, the characterize power consumption and energy output process 400 may begin at blocks 402 and 404, which may include computer-executable instructions directing the local processor 190 and/or the remote processor 200 to generate a power consumption model and a thermal energy model for the at least one temperature change component 110 to change a temperature of the water 103 within the receptacle 102 of a particular bathing unit system 100.

More specifically, in some embodiments, block 402 may direct the local processor 190 and/or the remote processor 200 to generate each of (a) a power consumption model for the primary heater 150 modelling an amount of power P drawn by the heating element from the power source 116 when the controller 180 operates the primary heater 150 in the “low” mode, the “standard” mode and the “high” mode as described above. (b) a power consumption model for the primary cooler 152 modelling an amount of power drawn P by the thermoelectric cooling element from the power source 116 when the controller 180 operates the primary cooler 152 in the “low” mode, the “standard” mode and the “high” mode as described above, and (c) a power consumption model for the auxiliary heater/cooler 154 modelling an amount of power P drawn by the heat pump from the power source 116 when the controller 180 operates the auxiliary heater/cooler 154 in the “low” mode, the “standard” mode and the “high” mode as described above. For example, in embodiments where the power source 116 comprises an electrical power source having a particular voltage (e.g., 240V DC as described above), block 402 may direct the local processor 190 to determine a current transmitted by the controller 180 to the primary heater 150, the primary cooler 152 and the auxiliary heater/cooler 154 while operating these different temperature change components in the corresponding operational modes. For example, in some embodiments, the at least one sensor 112 of a particular bathing unit system 100 includes an ammeter or a multimeter coupled to the controller 180. This allows the local processor 190 to determine a wattage consumption of the primary heater 150, the primary cooler 152 and the auxiliary heater/cooler 154 while these components are operating in the different operational modes. Block 402 may then direct the local processor 190 to (a) determine duration of use to generate power consumption data (e.g., hourly power consumption data, daily power consumption data, weekly power consumption data, etc.) and (b) determine time of use and retrieve cost of power to generate cost of use data (e.g., hourly cost of use data, daily cost of use data, weekly cost of use data).

Block 402 may also direct the local processor 190 and/or the remote processor 200 to convert the amount of power drawn P by the at least one temperature change component 110 from the power source 116 into an amount of power inputted Pᵢₙ (or drawn Pₒᵤₜ) by the at least one temperature change component 110 into the water 103 using constants or specifications associated with design of the at least one temperature change component 110 (e.g., type of heating element, resistance, current ambient temperature, operation of additional components, etc.) as known by one of ordinary skill in the art. In such embodiments, the power consumption model associated with a particular temperature change component 110 (e.g., the primary heater 150, the primary cooler 152 or the auxiliary heater/cooler 154) may also model an amount of power inputted Pᵢₙ (or drawn Pₒᵤₜ) by the particular bathing unit components into the water 103 when the particular bathing unit component is operating in the different modes as described above.

In some embodiments, block 404 may direct the local processor 190 and/or the remote processor 200 to generate each of (a) a thermal energy model for the primary heater 150 modelling an amount of thermal energy inputted Eᵢₙ by the primary heater 150 into the water 103 in the circulation system 104 when the controller 180 operates the primary heater 150 in the “low” mode, the “standard” mode and the “high” mode as described above. (b) a thermal energy model for the primary cooler 152 modelling an amount of thermal energy removed Eₒᵤₜ by the primary cooler 152 from the water 103 when the controller 180 operates the primary cooler 152 in the “low” mode, the “standard” mode and the “high” mode as described above, and (c) a thermal energy model for the auxiliary heater/cooler 154 modelling an amount of thermal energy inputted and an amount of thermal energy removed Eₙₑₜ (as applicable), by the auxiliary heater/cooler 154 into or from the water 103 when the controller 180 operates the auxiliary heater/cooler 154 in the “low” mode, the “standard” mode and the “high” mode as described above. For example, block 404 may direct the local processor 190 and/or the remote processor 200 to use the power consumption models generated at block 402 to determine the amount of power P drawn by the primary heater 150 from the power source 116 and/or the amount of power Pᵢₙ inputted by the primary heater 150 into the water 103, and estimate a corresponding amount of thermal energy inputted Eᵢₙ by the heating element based on specifications of the primary heater 150 (e.g., resistance of the heating element) and the determined amount of power consumed and/or inputted. Additionally or alternatively, block 404 may direct the local processor 190 and/or the remote processor 200 to determine the amount of power consumed by the primary cooler 152 or the auxiliary heater/cooler 154 from the power source 116 and estimate the amount of thermal energy inputted Eᵢₙ or an amount of thermal energy removed Eₒᵤₜ (as applicable) by the cooling element or the heat pump based on specifications of the primary cooler 152 and/or the auxiliary heater/cooler 154. As briefly described above, the auxiliary heater/cooler 154 may draw less energy from the power source 116 when compared to either the primary heater 150 or the primary cooler 152.

Still referring to FIG. 6, the characterize power consumption and energy output process 400 may also begin at blocks 406 and 408, which may include computer-executable instructions directing the local processor 190 and/or the remote processor 200 to generate a power consumption model and a thermal energy model for the at least one pump 106 which function to circulate the water 103 thorough the circulation system 104 of a particular bathing unit system 100.

More specifically, in some embodiments, block 406 may direct the local processor 190 and/or the remote processor 200 to generate each of (a) a power consumption model for the first pump 130 modelling an amount of power P drawn by the motor of the first pump 130 from the power source 116 when the controller 180 operates the first pump 130 in the “low” mode, the “standard” mode and the “high” mode as described above. (b) a power consumption model for the second pump 132 modelling an amount of power P drawn by the motor of the second pump 132 from the power source 116 when the controller 180 operates the second pump 132 in the “on” mode, and (c) a power consumption model for the third pump 134 modelling an amount of power P drawn by the motor of the third pump 134 from the power source 116 when the controller 180 operates the third pump 134 in the “on” mode as described above. For example, similar to block 402, in embodiments where the power source 116 comprises an electrical power source having a particular voltage (e.g., 240V DC as described above), block 404 may direct the local processor 190 to determine a current transmitted by the controller 180 to the first pump 130, the second pump 132 and the third pump 134 while operating these different pumps in the corresponding operational modes. This allows the local processor 190 to determine a wattage consumption of the first pump 130, the second pump 132 and the third pump 134 while these components are operating in the different operational modes. Again similar to block 402, block 406 may then direct the local processor 190 to (a) determine duration of use to generate power consumption data (e.g., hourly power consumption data, daily power consumption data, weekly power consumption data, etc.) and (b) determine time of use and retrieve cost of power to generate cost of use data (e.g., hourly cost of use data, daily cost of use data, weekly cost of use data).

Block 406 may also direct the local processor 190 and/or the remote processor 200 to convert the amount of power drawn P by the at least one pump 106 from the power source 116 into an amount of power inputted Pᵢₙ by the at least one pump 106 into the water 103 using constants associated with a design of the at least one pump 106 (e.g., pump type, rotor type, current ambient temperature, operation of additional components, etc.) as known by one of ordinary skill in the art. In such embodiments, the power consumption model associated with a particular pump 106 (e.g., the first pump 130, the second pump 132 or the third pump 134) may also model an amount of power inputted Pᵢₙ by the particular pump 106 into the water 103 when the particular pump 106 is operating in the different modes as described above.

In some embodiments, block 408 may direct the local processor 190 and/or the remote processor 200 to generate each of (a) a thermal energy model for the first pump 130 modelling an amount of thermal energy inputted Eᵢₙ by the first pump 130 into the water 103 when the controller 180 operates the first pump 130 in the “low” mode, the “standard” mode and the “high” mode as described above, (b) a thermal energy model for the second pump 132 modelling an amount of thermal energy inputted E by the second pump 132 into the water 103 when the controller 180 operates the second pump 132 in the “on” mode, and (c) a thermal energy model for the third pump 134 modelling an amount of thermal energy inputted Eᵢₙ by the third pump 134 into the water 103 when the controller 180 operates the third pump 134 in the “on” mode. As described above, agitation of the water 103 by impellers of the first pump 130, the second pump 132 and the third pump 134 as the water 103 is circulated by these pumps may kinetically input thermal energy into the water 103. For example, block 408 may direct the local processor 190 and/or the remote processor 200 to use the power consumption models generated at block 406 to determine the amount of power drawn by the motors of the first pump 130 from the power source 116 and/or or the amount of power Pᵢₙ inputted by the first pump 130 into the water 103, and estimate a corresponding amount of thermal energy inputted Eᵢₙ based on specifications of the first pump 130 (e.g., an electric resistance of the motor, a shape and angle of the rotors) and the determined amount of power consumed and/or inputted. Additionally, referring briefly to FIG. 2, as the first pump 130, the second pump 132 and the third pump 134 may be placed within the interior of the cabinet 101 of the particular bathing unit system 100, the motors of these pumps may produce thermal energy which may be transferred through the receptacle 102 (e.g., via conduction) into the water 103 in the receptacle 102, or through the conduits 124 into the water 103 in the conduits 124 (e.g., again via conduction).

### Optimize Temperature Change Process 500

While the controller 180 is operating the bathing unit system 100 in an operational mode (such as the standby mode, the temperature change mode and/or the use mode), the local processor 190 and/or the remote processor 200 may initiate the optimize temperature change process 500. The optimize temperature change process 500 may include computer-executable instructions directing the local processor 190 and/or the remote processor 200 to control the at least one temperature change component 110 (and optionally also the at least one pump 106) mode based at least in part on (a) the power consumption model and the thermal energy model thereof determined using the characterize power consumption and energy output process 400 and/or (b) the at least one thermal property indicator of the particular bathing unit system 100 derived using the determine thermal properties process 300.

The optimize temperature change process 500 may further include computer-executable instructions directing the local processor 190 and/or the remote processor 200 to control the at least one temperature change component 110 (and optionally, also the at least one pump 106) based on at least one received extrinsic parameter and at least one calculated intrinsic parameter as described below. Varied control of the at least one temperature change component 110 may reduce an amount of power, cost of power, and/or a time required to change a current water temperature T_{wat_current} of the water 103 to a target or desired bathing temperature T_{wat_final}.

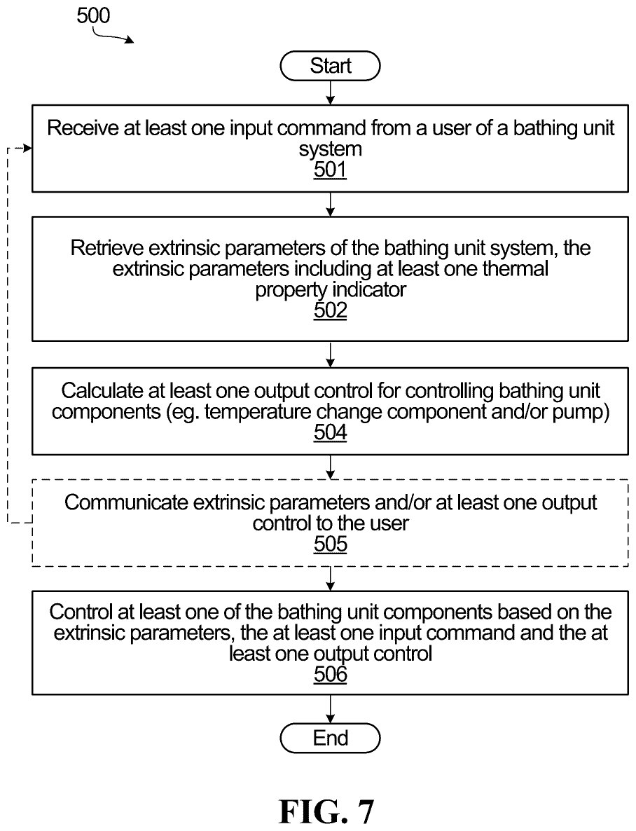

One embodiment of the optimize temperature change process 500 is shown in FIG. 7, and in the embodiment shown, the optimize temperature change process 500 is performed by a combination of the local and remote processors 190 and 200 executing processor-executable instructions and/or computer-executable instructions stored in the program memories 194 and 204 as applicable. In other embodiments, the optimize temperature change process 500 may comprise instructions stored on other types of non-transitory computer-readable storage medium. In yet other embodiments, the optimize temperature change process 500 and/or parts thereof may be executed entirely by the local processor 190, executed entirely by the remote processor 200 and/or executed by a system other than the local and remote processors 190 and 200. Further, although the optimize temperature change process 500 in accordance with one embodiment is described with reference to the flowchart illustrated in FIG. 7, other methods of implementing the optimize temperature change process 500 may alternatively be used. For example, the order of execution of the blocks shown in FIG. 7 may be altered, and/or some of the blocks described may be altered, eliminated, or combined.

Referring to FIG. 7, the optimize temperature change process 500 may begin at block 501, which may include computer-executable instructions directing the local processor 190 and/or the remote processor 200 to receive at least one input command from a user of the bathing unit system. As will be described below, the at least one input command may comprise inputs indicating a desired bathing experience. For example, the at least one input command may include the target or desired bathing temperature T_{wat_final} to use the bathing unit system 100, an indication of an initial time point tᵢₙᵢₜᵢₐₗ to activate the at least one temperature change component 110, a desired final time point t_{final} to use the bathing unit system 100, and/or a user profile associated with a user of the bathing unit system 100 including a habitual bathing temperature T_{wat_final} and a habitual bathing time point t_{final}.

The optimize temperature change process 500 may then continue to block 502, which may include computer-executable instructions directing the local processor 190 and/or the remote processor 200 to retrieve extrinsic parameters of the particular bathing unit system 100. As will be described below, extrinsic parameters may comprise existing parameters associated with the particular bathing unit system 100. For example, the extrinsic parameters may include a current water temperature T_{wat_current} of the water 103, a current ambient temperature T_{amb}_current, a predicted future ambient temperature T_{amb}_pred, a change in ambient temperature T′_{amb_current}, the power consumption models and the thermal energy models for operating different bathing unit components, and the one or more thermal property indicators for the particular bathing unit system 100.

The optimize temperature change process 500 may then continue to block 504, which may include computer-executable instructions directing the local processor 190 and/or the remote processor 200 to calculate at least one output control for controlling the bathing unit system 100 based on the extrinsic parameters (including the power consumption models and the thermal energy models for operating different bathing unit components and the thermal property indicators of the particular bathing unit system 100) and the at least one input command. As will be described below, such output controls may include an amount of power Pᵢₙ or an amount of energy Eᵢₙ required to be inputted into the water 103, an initial time point tᵢₙᵢₜᵢₐₗ for activating the at least one temperature change component 110 (and/or the at least one pump 106) and the final time point t_{final} for deactivating the at least one temperature change component 110 (and/or the at least one pump 106).

For example, in some embodiments, block 504 may direct the local processor 190 and/or the remote processor 200 to take into account an amount of power required to be inputted Pᵢₙ into the water 103 and an amount of power lost Pₒᵤₜ by the particular bathing unit system 100 based on equation (22) below:

$$\frac{d {T}_{w a t}}{d t} = \frac{d {T}_{wat \_ in}}{d t} - \frac{d {T}_{wat \_ out}}{d t} \qquad ( 22 )$$

Whereby dT_{wat} is a change in water temperature of the water 103 within the receptacle 102 and has units of ° C.; dt is an infinitesimal period of time and has units of s;

$$\frac{d {T}_{w a t}}{d t} ;$$

is a differential operator proportional to the k constant and a difference between T_{wat} and T_{amb} as per equations (3) and (4) above;

$$\frac{d {T}_{wat \_ in}}{d t}$$

is the portion of

$$\frac{d {T}_{w a t}}{d t}$$

representing amount of power inputted Pᵢₙ into the water 103; and

$$\frac{d {T}_{wat \_ out}}{d t}$$

is the portion of

$$\frac{d {T}_{w a t}}{d t}$$

representing an amount of power lost Pₒᵤₜ from the water 103. Both

$$\frac{d {T}_{wat \_ in}}{d t} and \frac{d {T}_{wat \_ out}}{d t}$$

may be proportional to an insulating capacity of the at least one insulating component 114.

In situations where the water temperature T_{wat} is greater than ambient temperature T_{amb},

$$\frac{d {T}_{wat \_ in}}{d t}$$

may be calculated based on (a) a known amount of power inputted Pᵢₙ into the water 103 as a result of activation of the at least one temperature change component 110 and/or the at least one pump 106 (e.g., determined at blocks 402 and 406 of the characterize power consumption and energy output process 400) and (b) the water mass m_{wat} of the water 103 (e.g., determined at block 302 of the determine thermal properties process 300), using equation (23) below:

$$\frac{d {T}_{wat \_ in}}{d t} = \frac{{P}_{i n}}{{m}_{w a t} {C}_{p}} \qquad ( 23 )$$

whereby m_{wat} is the water mass of the water 103 in the receptacle 102 and has units of kg; Cₚ is the heat capacity of water which is approximately

$$4180 \frac{J}{kg ° C .} ;$$

and Pᵢₙ is an amount of power inputted (or rate of thermal energy Eᵢₙ inputted) into the water 103 as a result of activation of the at least one temperature change component 110 and the at least one pump 106 (e.g., determined using the thermal energy models generated at blocks 402 and 406 of the characterize power consumption and energy output process 400) and has units of J/s.

In situations where the water temperature T_{wat} is greater than ambient temperature T_{amb},

$$\frac{d {T}_{wat \_ out}}{d t}$$

may be calculated based on (a) the known thermal conductivity H of the particular bathing unit system 100 (e.g., determined using the determine thermal properties process 300 and which may be stored in the thermal properties data stores 303 and 313) and (b) an ambient temperature of the environment around the particular bathing unit system 100 (e.g., measured using the ambient temperature sensor 164), using equation (24) below:

$$\frac{d {T}_{wat \_ out}}{d t} = - \frac{H}{{m}_{w a t} {C}_{p}} ( {T}_{w a t} ( t ) - {T}_{a m b} ) \qquad ( 24 )$$

whereby T_{wat} (t) is a water temperature of the water 103 within the receptacle 102 at any particular point in time t and has units of ° C.; T_{amb} is the ambient temperature of the environment around the particular bathing unit system 100 and also has units of ° C. and may be a constant as described above; H is the known thermal conductivity of the particular bathing unit system 100; m_{wat} is the water mass of the water 103 in the receptacle 102; and Cₚ is the heat capacity of water.

Equations (23) and (24) can then be inserted into equation (22) to generate equation (25) below:

$$\frac{d {T}_{w a t}}{d t} = \frac{{P}_{i n}}{{m}_{w a t} {C}_{p}} - \frac{H}{{m}_{w a t} {C}_{p}} ( {T}_{w a t} ( t ) - {T}_{a m b} ) \qquad ( 25 )$$

As described above in association with equations (26.1) and (28.1), it is possible to determine a maximum water temperature T_{wat_max} which can be reached by the water 103 due to a known amount of power inputted Pᵢₙ into the water 103 according to equation (26) below.

$${T}_{wat \_ max} = ( {P}_{i n} \times Θ ) + {T}_{a m b} \qquad ( 26 )$$

whereby T_{wat_max} is the maximum water temperature which can be reached due to a known amount of power inputted Pᵢₙ into the water 103 as a result of activation of the at least one temperature change component 110 and/or the at least one pump 106; @ is the thermal resistance of the bathing unit system 100 (e.g., determined at sub-blocks 314, 324 and/or 336 of the determine thermal properties process 300); and T_{amb} is the constant ambient temperature.

The thermal resistance Θ is the inverse of the thermal conductivity H of the bathing unit system 100 (e.g., see equation (21)). As a result, equation (26) above may be converted into equation (27) below, and which may be rearranged into equation (28) below to isolate Pᵢₙ:

$${T}_{wat \_ max} = \frac{{P}_{in}}{H} + {T}_{a m b} \qquad ( 28 )$$

$${P}_{i n} = H ( {T}_{wat \_ max} - {T}_{a m b} ) \qquad ( 29 )$$

Thereafter, equation (29) can be inserted into the equation (25) to generate equation (30) below, which may be simplified into equation (31) below:

$$\frac{d {T}_{w a t}}{d t} = \frac{H}{{m}_{w a t} {C}_{p}} ( {T}_{wat \_ max} - {T}_{a m b} ) - \frac{H}{{m}_{w a t} {C}_{p}} ( {T}_{wat} ( t ) - {T}_{a m b} ) \qquad ( 30 )$$

$$\frac{d {T}_{w a t}}{d t} = \frac{H}{{m}_{w a t} {C}_{p}} ( {T}_{wat \_ max} - {T}_{w a t} ( t ) ) \qquad ( 31 )$$

Equation (31) illustrates how

$$\frac{d {T}_{w a t}}{d t}$$

is proportional to the term

$$\frac{H}{{m}_{w a t} {C}_{p}}$$

and a difference between T_{wat_max} and T_{wat} (t). Further, at T_{wat_max},

$$\frac{d {T}_{wat \_ in}}{d t} = \frac{{dT}_{wat \_ out}}{d t}$$

as T_{wat_max} is the maximum water temperature which can be reached due to a known amount of power inputted Pᵢₙ into the water 103 and is thus generally also a thermal equilibrium water temperature T_{wat_equit} for that Pᵢₙ, whereby the amount of power inputted Pᵢₙ into water 103 in the receptacle 102 has the same value as the amount of power outputted Pₒᵤₜ towards environment around the bating unit system 100. Equation (31) may then be simplified using the assumptions that (a) at an initial time point T_{wat} (t)=T_{amb} and that (b) at a final time point T_{wat} (t)=T_{wat}_max, and may be integrated based on an integration constant at initial conditions where T_{wat} (t)=T_{amb} to generate equation (33) below:

$$\frac{{T}_{wat \_ max} - {T}_{w a t} ( t )}{{T}_{wat \_ max} - {T}_{amb}} = {e}^{- \frac{H}{{m}_{wat} {C}_{p}} t} \qquad ( 33 )$$

Equation (33) can then be rearranged to isolate T_{wat} (t) to generate equation (34) below:

$${T}_{w a t} ( t ) = {T}_{wat \_ max} - ( {T}_{wat \_ max} - {T}_{a m b} ) {e}^{- \frac{H}{{m}_{wat} {C}_{p}} t} \qquad ( 34 )$$

Equation (34) generally allows determination of a temperature of the water 103 at any particular point in time T_{wat} (t) based on T_{amb} and a thermal conductivity H of the particular bathing unit system 100.

The T_{amb} may be retrieved using the ambient temperature sensor 164. The thermal conductivity H of the particular bating unit system 100 may be determined using the determine thermal properties process 300 described above (e.g., sub-blocks 314, 324 and 336 thereof).

In discrete form, the rate of change of water temperature during a determination time period of time ta may be represented using equation (35) below:

$$\frac{Δ {T}_{w a t}}{Δ t} = \frac{( {T}_{wat \_ new} - {T}_{wat \_ now} )}{{t}_{new} - {t}_{now}} \qquad ( 35 )$$

whereby T_{wat}_now is a discrete temperature of the water 103 at t_{now} (e.g., as measured by the receptacle temperature sensor 160); T_{wat_new} is a discrete temperature of the water 103 at t_{new} (e.g., as measured by the receptacle temperature sensor 160); ΔT_{wat} is a difference between the discrete values T_{wat} new and T_{wat} now; and Δt is a difference between the discrete values t_{new} and t_{now}.

Equation (35) may be repeated multiple times over multiple time points (e.g., every 1 second, every 0.5 seconds, every 0.1 seconds etc.) over a period of time, which allows generation of a representation of a temperature curve of the water 103 over time for a particular bathing unit system 100. From the generated temperature curve, the discrete

$$\frac{Δ {T}_{w a t}}{Δ t}$$

may be derived and the differential operator

$$\frac{d {T}_{w a t}}{d t}$$

may be approximated. In situations where ΔT_{wat} represents a change of water temperature and Δt represents an infinitesimal amount of time

$$\frac{Δ {T}_{w a t}}{Δ t} \approx \frac{d {T}_{w a t}}{d t} .$$

In this regard, one of ordinary skill in the art would recognize that the smaller the Δt, the closer

$$\frac{Δ {T}_{w a t}}{Δ t} \approx \frac{d {T}_{w a t}}{d t} .$$

In such situations, and equation (23) may be rewritten as discrete equation (36) below:

$$\frac{Δ {T}_{w a t}}{Δ t} = \frac{{P}_{in}}{{m}_{w a t} {C}_{p}} - \frac{H}{{m}_{w a t} {C}_{p}} ( {T}_{wat \_ max} - {T}_{a mb \_ now} ) \qquad ( 36 )$$

whereby T_{wat} now is a discrete temperature of the water 103 at t_{now} (e.g., as measured by the receptacle temperature sensor 160); T_{amb} now is a discrete temperature of the environment around the particular bathing unit system 100 at t_{now} (e.g., as measured by the ambient temperature sensor 164); Pᵢₙ is a known amount of power inputted into the water 103 as a result of activation of the at least one temperature change component 110 and/or the at least one pump 106; H is the known thermal conductivity of the particular bathing unit system 100; m_{wat} is the water mass of the water 103 in the receptacle 102; and Cₚ is the heat capacity of water.

Equation (36) may then be combined with equation (35) to produce equation (37) below, which may be rearranged to isolate T_{wat_new} as equation (38) below:

$$\frac{( {T}_{wat \_ new} - {T}_{wat \_ now} )}{{t}_{new} - {t}_{now}} = \frac{{P}_{in}}{{m}_{w a t} {C}_{p}} - \frac{H}{{m}_{w a t} {C}_{p}} ( {T}_{wat \_ now} - {T}_{amb \_ now} ) \qquad ( 37 )$$

$${T}_{wat \_ new} - {T}_{wat \_ now} + \frac{{t}_{new} - {t}_{now}}{m {C}_{p}} ( {P}_{i n} - H ( {T}_{wat \_ now} - {T}_{amb \_ now} ) ) \qquad ( 38 )$$

Equation (38) provides a discrete equation for inputting different parameters (e.g., the retrieved extrinsic parameters, the at least one received input command) to heat a particular bathing unit system 100 to a final water temperature T_{wat} new while accounting for the thermal property indicator (e.g., the thermal conductivity H) of the particular bathing unit system 100 and a current ambient temperature T_{amb}_now.

The optimize temperature change process 500 may then continue to optional block 505, which may include computer-executable instructions directing the local processor 190 and/or the remote processor 200 to display or otherwise communicate (e.g., via the control panel 198 or the user device 184) the at least one output control calculated at block 504 and/or the extrinsic parameters retrieved at block 502 to the user of the bathing unit system 100. The user may then provide additional user input (e.g., again via the control panel 198 or the user device 184) of at least one further input command (which may be a modification of the at least one output control calculated at block 504) and the optimize temperature change process 500 may return to block 501 and continue therefrom.

The optimize temperature change process 500 may also continue to block 506, which may include computer-executable instructions directing the local processor 190 and/or the remote processor 200 to adjust control of the at least one temperature change component 110 and/or control of the at least one pump 106 based on the retrieved extrinsic parameters, the received at least one input command and the calculated at least one output control.

### Example 1: Determine Final Time Point t_{Final}

For example, in one embodiment, a user may input a particular target bathing temperature T_{wat_final}, (e.g., via the control panel 198 and/or the user device 184 associated with the user) as an input command at block 501.

Block 502 may then direct the local processor 190 and/or the remote processor 200 to (a) retrieve the thermal conductivity H of the particular bathing unit system 100 from the thermal properties data store 303 or 313, a current water temperature T_{wat_current} from the receptacle temperature sensor 160 and a current ambient temperature T_{amb}_current from the ambient temperature sensor 164, (b) retrieve water mass m_{wat} in a manner similar to that described above in association with block 302 of the determine thermal properties process 300, (c) retrieve a standard amount of power inputted Pᵢₙ into the water 103 based on operation of the at least one temperature change component 110 and/or the at least one pump 106 (e.g., based on the power consumption models for operating the at least one temperature change component 110 and/or the at least one pump 106 determined using blocks 402 and/or 406 of the characterize power consumption and energy output process 400) and (d) assume that the initial time point tᵢₙᵢₜᵢₐₗ=0, all as separate extrinsic parameters.

Block 504 may then direct the local processor 190 and/or the remote processor 200 to calculate (as an output control) a final time point t_{final} at which the target bathing temperature T_{wat_final} received at block 501 would be reached given the extrinsic parameters retrieved at block 502. For example, block 504 may use equation (38) whereby tᵢₙᵢₜᵢₐₗ=t_{now}=0, T_{amb_current}=T_{amb_now} and T_{wat_final}=T_{wat} new to solve for t_{final}=t_{new}.

Block 505 may then direct the local processor 190 and/or the remote processor 200 to communicate this determined final time point t_{final} to the user (e.g., via the control panel 198 and/or the user device 184). In response, the user may accept the determined final time point t_{final} and may and return to the particular bathing unit system 100 at the determined final time point t_{final}. In such embodiments, block 506 may direct the local processor 190 to operate to the bathing unit components (e.g., in the temperature change mode) based on the input command received at block 501, the extrinsic parameters retrieved at block 502, and the output control calculated at block 504 so that the calculated standard amount of power Pᵢₙ is inputted into the water 103 between the initial time point tᵢₙᵢₜᵢₐₗ and the determined final time point t_{final}. For example, the local processor 190 may operate the primary heater 150 in the “standard” mode or at a 50% modulated percentage, the auxiliary heater/cooler 154 in the “off”′ mode, the first pump 130 in the “low” mode and the second and third pumps 132 and 134 in the “off”′ mode.

Alternatively, in response, the user may provide an additional input command (e.g., via the control panel 198 and/or the user device 184) indicating that the user would prefer to use the bathing unit system 100 prior to the determined final time point t_{final} and may provide an indication of a desired final time point t′_{final} (e.g., which may be received as an additional input command at block 501). Based on the desired final time point t′_{final} as an additional input command, the optimize temperature change process 500 may return to block 504 to direct the local processor 190 and/or the remote processor 200 to calculate a required amount of power P′ᵢₙ (e.g., which may be an additional calculated output control) to be inputted into the water 103 to reach the target bathing temperature T_{wat_final} at the desired time point t′_{final}. Based on the determined required amount of power P′ᵢₙ, block 506 may direct the local processor 190 to instead control the bathing unit components differently (e.g., in the temperature change mode) based on the additional input command retrieved at block 502 and the modified calculated output controls calculated at block 504 so that the required amount of power P′ᵢₙ is inputted into the water 103 between the initial time point tᵢₙᵢₜᵢₐₗ and the desired final time point t′_{final}. For example, the local processor 190 may operate the primary heater 150 in the “high” mode or at a higher modulated percentage, operate the auxiliary heater/cooler 154 in the “on” mode to provide additional power Pᵢₙ, by operating at the first pump 130 in the “high” mode to provide additional power Pᵢₙ and/or by operating the second pump 132 or the third pump 134 in the “on” again to provide additional power Pᵢₙ.

### Example 2: Determine Initial Time Point t_{Initial} Based on Target Bathing Temperature T_{wat_final} and desired final time point t_{final}

In yet other embodiments, a user may input (e.g., via the control panel 198 or the user device 184) both a target bathing temperature T_{wat_final} and a desired time point t_{final} that the user will use the bathing unit system 100 as input commands at block 501.

In some embodiments, rather than the user inputting the target bathing temperature T_{wat_final} and desired time point t_{final}, the user may instead be associated with a user profile (e.g., stored in the local storage memory 192 or the remote storage memory 202) which indicates both a habitual bathing temperature T_{wat_final} and a habitual time point t_{final} at which the user uses the bathing unit system 100. In such embodiments, block 502 may direct the local processor 190 and/or the remote processor 200 to transmit at least one confirmation message to the user device 184 requesting the user to confirm use of the particular bathing unit system 100 at the habitual bathing temperature T_{wat_final} and the habitual time point t_{final}, and may retrieve the habitual bathing temperature T_{wat_final} and the habitual time point t_{final} as input commands at block 501 only after receipt of the confirmation from the user (e.g., a confirmation message transmitted between the user device 184 and the local processor 190 and/or the remote processor 200).

Block 502 may then direct the local processor 190 and/or the remote processor 200 to (a) retrieve a current thermal conductivity H of the particular bathing unit system 100 from the thermal properties data store 303 or 313, a current water temperature T_{wat_current} from the receptacle temperature sensor 160 and a current ambient temperature T_{amb}_current from the ambient temperature sensor 164, (b) retrieve the water mass m_{wat}, (c) retrieve a standard amount of power inputted Pᵢₙ into the water 103 based on operation of the at least one temperature change component 110 and/or the at least one pump 106 (e.g., based on the power consumption models for operating the at least one temperature change component 110 and the at least one pump 106 determined using blocks 402 and/or 406 of the characterize power consumption and energy output process 400), all as separate extrinsic parameters.

Block 504 may then direct to the local processor 190 and/or the remote processor 200 to derive (as an output control) an initial time point tᵢₙᵢₜᵢₐₗ to activate bathing unit components (e.g., the at least one temperature change component 110 and the at least one pump 106) to ensure that the water 103 reaches the desired or habitual bathing temperature T_{wat_final} at the desired or habitual final time point t_{final}. For example, block 504 may use equation (38) whereby T_{amb_current}=T_{amb}_now, T_{wat_final}=T_{wat} new, and t_{final}=t_{new} to solve for tᵢₙᵢₜᵢₐₗ=t_{now}. Determining the initial time point tᵢₙᵢₜᵢₐₗ to active the bathing unit components may improve the energy efficiency of the bathing unit system 100, as the at least one temperature change component 110 and/or the at least one pump 106 would not need to be turned on or draw any power from the power source 116 before the determined initial time point tᵢₙᵢₜᵢₐₗ.

Block 506 may then direct the local processor 190 to operate the bathing unit components (e.g., in the temperature change mode) based on the input commands received at block 501, the extrinsic parameters retrieved at block 502, and the output control calculated at block 504. For example, block 506 may direct the local processor 190 to activate the at least one temperature change component 110 and the at least one pump 106 at the determined initial time point tᵢₙᵢₜᵢₐₗ so that there is sufficient time to input the calculated standard amount of power Pᵢₙ into the water 103 to reach the desired or habitual bathing temperature T_{wat_final} at the desired or habitual time point t_{final}. For example, the local processor 190 may activate the primary heater 150 in the “standard” mode or at a standard modulated percentage and the first pump 130 in the “low” mode at the determined initial time point tᵢₙᵢₜᵢₐₗ, while maintaining the auxiliary heater/cooler 154, the second pump 132 and the third pump 134 in the “off” mode. As described above, this may reduce the cost of energy to operate the bathing unit system 100, as operating only the primary heater 150 and the first pump 130 to reach the desired or habitual bathing temperature T_{wat_final} at the desired or habitual time point t_{final} may draw less power from the power source 116 when compared to operating every single one of the primary heater 150, the auxiliary heater/cooler 154, the first pump 130, the second pump 132 and the third pump 134. Additionally, only operating the primary heater 150 and the first pump 130 between the determined initial time point tᵢₙᵢₜᵢₐₗ and the desired or habitual time point t_{final} may also reduce the cost of energy to operate the bathing unit system 100, particularly when compared with constantly operating the primary heater 150 and the first pump 130 in anticipation of potential use by a user.

### Example 3: Account for Cost of Energy to Input Thermal Energy Eᵢₙ

In other embodiments, a cost of power to operate the bathing unit system 100 may also be received as an extrinsic parameter at block 502. For example, the cost to operate the bathing unit components may include electricity costs in embodiments where the power source 116 supplies electrical power, oil costs in embodiments where the at least one power source 116 is an oil-based boiler, gas costs in embodiments where the at least one power source 116 is a gas-based boiler, etc. In such embodiments, times of day associated with peak costs (e.g., 6 AM-10 AM, 5 PM-12 AM) and non-peak costs (e.g., 12 AM-6 AM, 10 AM-5 PM) may be provided by an energy service provider or may be inputted by the user (e.g., via the control panel 198 and/or the user device 184) as extrinsic parameters at block 502.

In such embodiments, block 501 may direct the local processor 190 and/or the remote processor 200 to receive a target bathing temperature T_{wat_final} and a desired time point t_{final} that the user will use the bathing unit system 100 from the user (or the user profile) as described above, as input commands.

Block 502 may then direct the local processor 190 and/or the remote processor 200 to retrieve a current thermal conductivity H of the particular bathing unit system 100 from the thermal properties data store 303 or 313, a current water temperature T_{wat_current} from the receptacle temperature sensor 160 and a current ambient temperature T_{amb}_current from the ambient temperature sensor 164, and water mass m_{wat}, and electricity costs at different times of day, all as extrinsic parameters.

Block 504 may then direct the local processor 190 and/or the remote processor 200 to determine (as output controls) an initial time point tᵢₙᵢₜᵢₐₗ to activate bathing unit components (e.g., the at least one temperature change component 110 and the at least one pump 106) and an amount of power Pᵢₙ required to be inputted into the water 103 when at least one of the initial time point tᵢₙᵢₜᵢₐₗ, the final time point t_{final} and/or the period between the time points t_{final} and tᵢₙᵢₜᵢₐₗ is during a time of day associated with non-peak costs. For example, block 504 may direct the local processor 190 and/or the remote processor 200 to determine that to reach the target bathing temperature T_{wat_final} at the desired final time point t_{final} of 7 PM, it is necessary to operate the primary heater 150 to input certain amount of power Pᵢₙ between 5 PM-7 PM (which will be associated with peak costs). However, the local processor 190 and/or the remote processor 200 may determine that it is also possible to reach a higher water temperature T_{wat} high by operating the primary heater 150 to input a higher amount of power P′ᵢₙ between 3 PM-5 PM (which will be associated with non-peak costs) and to allow the water 103 to cool down between 5 PM-7 PM so that the water 103 is at the target bathing temperature T_{wat_final} at the desired final time point t_{final} of 7 PM. The higher water temperature T_{wat}_high and the initial time point t_{final} may be determined based on the thermal conductivity H of the particular bathing unit system 100. Alternatively or additionally, the local processor 190 and/or the remote processor 200 may also determine that it is possible to reach the target bathing temperature T_{wat_final} by operating the primary heater 150 to input certain amount of power Pᵢₙ between 3 PM-5 PM (again, which will be associated with non-peak costs), and then maintain the target bathing temperature T_{wat_final} by turning off the primary heater 150 and operating the auxiliary heater/cooler 154 to input a reduced amount of power P″ᵢₙ between 5 PM-7 PM (which will be associated with peak costs, but the auxiliary heater/cooler 154 may draw less power from the power source 116 when compared to the primary heater 150). Alternatively or additionally, block 505 may direct the local processor 190 and/or the remote processor 200 to transmit an alert message to the user (e.g., via the control panel 198 or the user device 184) in situations where the cost of power exceeds a pre-set threshold and may ask the user to confirm use of the bathing unit system, including use at the target bathing temperature T_{wat_final} at the desired final time point t_{final}.

Block 506 may then direct the local processor 190 to operate the bathing unit components (e.g., in the temperature change mode) based on the input commands received at block 501, the extrinsic parameters retrieved at block 502, and the output controls calculated at block 504 so that the water 103 is at the target bathing temperature T_{wat_final} at the desired final time point t_{final} while maintaining at least one of the initial time point tᵢₙᵢₜᵢₐₗ, the final time point t_{final} and/or the period between the time points t_{final} and tᵢₙᵢₜᵢₐₗ within a time of day associated with non-peak costs as appropriate. For example, depending on the output controls calculated at block 504, block 506 may direct the local processor 190 to operate the at least one temperature change component 110 and/or the at least one pump 106 in standard modes during a time of day associated with non-peak costs (e.g., at 3 PM) and then deactivate the at least one temperature change component 110 and/or the at least one pump 106 during a time of day associated with peak costs (e.g., at 5 PM). More specifically, block 506 may direct the local processor 190 to operate the primary heater 150 in the “standard” mode during a time of day associated with non-peak costs (e.g., at 3 PM) to heat the water 103 to the higher water temperature T_{wat}_high and operate the primary heater 150 in the “off”′ mode during the time of day associated with peak costs (e.g., at 5 PM), and to simply allow the water 103 to cool down to the target bathing temperature T_{wat_final} by the desired final time point t_{final}. This may avoid operating any temperature change components 110 at all while the cost of power is high. Additionally or alternatively, block 506 may direct the local processor 190 to operate the primary heater 150 in the “standard” mode during a time of day associated with non-peak costs (e.g., at 3 PM) to heat the water 103 to the target bathing temperature T_{wat2}, and then operate the primary heater 150 in the “off”′ mode and the auxiliary heater/cooler 154 in the “standard” mode during a time of day associated with peak costs (e.g., at 5 PM) to maintain the target bathing temperature T_{wat_final} during the time of day associated with peak costs (e.g., between 5 PM-7 PM) until the desired final time point t_{final}. This may avoid operating the primary heater 150 while the cost of power is high. As described above, the auxiliary heater/cooler 154 may consume less power than the primary heater 150, particularly when maintaining the water 103 at the target bathing temperature T_{wat_final}.

### Example 4: Account for Changes in Ambient Temperature T_{amb}

In yet other embodiments, a change in ambient temperature of the environment around the bathing unit system 100 may also be received as an extrinsic parameter at block 502. For example, current ambient temperatures T_{amb}_current may be retrieved in real time from the ambient temperature sensor 164 as extrinsic parameters. Additionally or alternatively, current ambient temperatures T_{amb}_current or forecasted ambient temperatures T_{amb} pred may be retrieved from online weather sources (e.g., by the local processor 190 or the remote processor 200 over the network 181) as extrinsic parameters.

In such embodiments, block 501 may then direct the local processor 190 and/or the remote processor 200 to receive a target bathing temperature T_{wat_final} and a desired time point t_{final} that the user will use the bathing unit system 100 from the user (or the user profile) as described above, as input commands.

Block 502 may then direct the local processor 190 and/or the remote processor 200 to retrieve a current thermal conductivity H of the particular bathing unit system 100 from the thermal properties data store 303 or 313, a current water temperature T_{wat_current} from the receptacle temperature sensor 160, and the water mass m_{wat}, the current ambient temperatures T_{amb}_current, and forecasted ambient temperatures T_{amb}_pred, all as extrinsic parameters.

Block 504 may then direct the local processor 190 and/or the remote processor 200 to determine (as output controls) an initial time point tᵢₙᵢₜᵢₐₗ to activate bathing unit components (e.g., the at least one temperature change component 110 and the at least one pump 106) and an amount of power Pᵢₙ required to be inputted into the water 103 based on a given the current ambient temperature T_{amb}_current and/or the forecasted ambient temperatures T_{amb} pred to ensure that the water 103 reaches the target bathing temperature T_{wat_final} and the desired time point t_{final}. For example, in situations where the current ambient temperature T_{amb} current increases and/or the forecasted ambient temperatures T_{amb}_pred is predicted to increase, block 504 may direct the local processor 190 and/or the remote processor 200 to determine that a later initial time point t′ᵢₙᵢₜᵢₐₗ and/or a lesser amount of power P′ᵢₙ may be required to be inputted into the water 103. In contrast, the current ambient temperature T_{amb}_current decreases and/or the forecasted ambient temperatures T_{amb} pred is predicted to decrease, block 504 may direct the local processor 190 and/or the remote processor 200 to determine that an earlier initial time point t″initial and/or a larger amount of power P″ᵢₙ may be required to be inputted into the water 103.

Block 506 may then direct the local processor 190 to operate the bathing unit components (e.g., in the temperature change mode) based on the input commands received at block 501, the extrinsic parameters retrieved at block 502, and the output controls calculated at block 504. For example, block 506 may direct the local processor 190 to activate the at least one temperature change component 110 and the at least one pump 106 at the determined earlier initial time point t″initial or the later initial time point t′ᵢₙᵢₜᵢₐₗ. Additionally or alternatively, block 506 may further direct the local processor 190 to operate the at least one temperature change component 110 and/or the at least one pump 106 to generate the determined lesser amount of power P′ᵢₙ required, and may, e.g., operate the primary heater 150 in the “low” mode or at a low modulated frequency and the first pump 130 in the “low” mode, while operating the auxiliary heater/cooler 154, the second pump 132 and third pump 134 in the “off” mode. Additionally or alternatively, block 506 may further direct the local processor 190 to operate the at least one temperature change component 110 and/or the at least one pump 106 to generate the determined larger amount of power P′ᵢₙ required, and may, e.g., operate the primary heater 150 in the “high” mode or at a higher modulated frequency, the auxiliary heater/cooler 154 in the “standard” mode, the first pump 130 in the “high” mode, and the second pump 132 and the third pump 134 in the “low” mode.

In some embodiments, the current ambient temperature T_{amb}_current detected by the ambient temperature sensor 164 (e.g., received as an extrinsic parameter at block 502) may differ from the forecasted ambient temperatures T_{amb} pred retrieved from the online weather provider sources. Additionally, the current ambient temperature T_{amb}_current may also change to a changed ambient temperature T′_{amb_current} while the bathing unit system 100 is in the temperature change mode or the use mode. In such embodiments, block 504 may direct the local processor 190 and/or the remote processor 200 to revise at least one of the initial time point tᵢₙᵢₜᵢₐₗ to activate the bathing unit components, the determined amount of power Pᵢₙ to be inputted into the water 103, the desired time point t_{final} at which the water 103 will be at the target bathing temperature T_{wat_final} and the target bathing temperature T_{wat_final} at a desired time point t_{final} to account for the change in the ambient temperature. For example, in situations where the current ambient temperature T_{amb}_current is greater than the predicted future ambient temperatures T_{amb}_pred, or where the changed ambient temperature T′_{amb_current} is greater than the original ambient temperature T_{amb} current, the block 504 may direct the local processor 190 and/or the remote processor 200 to determine a later initial time point t′ᵢₙᵢₜᵢₐₗ, a lesser amount of power P′ᵢₙ, an earlier final time point t′_{final} and/or a higher final water temperature T′wat_final. In contrast, in situations where the current ambient temperature T_{amb} current is lesser than the predicted future ambient temperatures T_{amb} pred, or where the changed ambient temperature T′_{amb_current} is lesser than the original ambient temperature T_{amb}_current, block 504 may direct the local processor 190 and/or the remote processor 200 to determine an earlier initial time point t″ᵢₙᵢₜᵢₐₗ, a larger amount of power P″ᵢₙ, a later final time point t″_{final} and/or a lower final water temperature T′_{wat_final}. One skilled in the art will appreciate that the receipt of the current ambient temperature T_{amb}_current and/or the changed ambient temperature T′_{amb_current} may occur after the local processor 190 has already activated bathing unit components (e.g., operating the bathing unit system 100 in the temperature change mode) or before the local processor 190 has activated the bathing unit components (e.g., operating the bathing unit system 100 in the standby mode).

Block 506 may then direct the local processor 190 to operate the bathing unit components based on the input commands received at block 501, the extrinsic parameters retrieved at block 502, and the output controls calculated at block 504. For example, block 506 may direct the local processor 190 to activate the at least one temperature change component 110 and/or the at least one pump 106 at the determined earlier initial time point t″ᵢₙᵢₜᵢₐₗ or the later initial time point t′ᵢₙᵢₜᵢₐₗ. Additionally or alternatively, block 506 may further direct the local processor 190 to operate the at least one temperature change component 110 and/or the at least one pump 106 to generate the determined lesser amount of power P′ᵢₙ, and may, e.g., operate the primary heater 150 in the “low” mode or at a low modulated frequency and the first pump 130 in the “low” mode, while operating the auxiliary heater/cooler 154, the second pump 132 and third pump 134 in the “off” mode. Additionally or alternatively, block 506 may further direct the local processor 190 to operate the at least one temperature change component 110 and/or the at least one pump 106 to generate the determined larger amount of power P″ᵢₙ, and may, e.g., operate the primary heater 150 in the “high” mode or at a higher modulated frequency, the auxiliary heater/cooler 154 in the “standard” mode, the first pump 130 in the “high” mode, and the second pump 132 and the third pump 134 in the “low” mode. Additionally or alternatively, block 505 may direct the local processor 190 and/or the remote processor 200 to display or otherwise communicate (e.g., via the control panel 198 or the user device 184) the earlier final time point t′_{final}, the higher final water temperature T′_{wat_final}, the later final time point t″_{final} and/or the lower final water temperature T″_{wat_final} to the user of the bathing unit system 100.

### Monitor Lifetime Thermal Properties Process 600

During a lifetime of the bathing unit system 100, the control system 118 may monitor changes in thermal properties of the bathing unit system 100 (e.g., determined using the determine thermal properties process 300) using the monitor lifetime thermal properties process 600. The monitor lifetime thermal properties process 600 may provide at least one subsequent thermal property indicator which can be used in a subsequent iteration of the characterize power consumption and energy output process 400 and the optimize temperature change process 500. Additionally, the at least one subsequent thermal property indicator may be compared with an initial thermal property indicator (e.g., determined using the determine thermal properties process 300 when the bathing unit system 100 was manufactured or initially installed in the field location) or with an previously derived thermal property indicator (e.g., determined using a previous iteration of the determine thermal properties process 300) to determine a current insulative capacity (e.g., correlated to a current condition) of the at least one insulating component 114 of the particular bathing unit system 100. The initial thermal property indicator and/or the previously derived thermal property indicator may be used as a “reference thermal property indicator”.

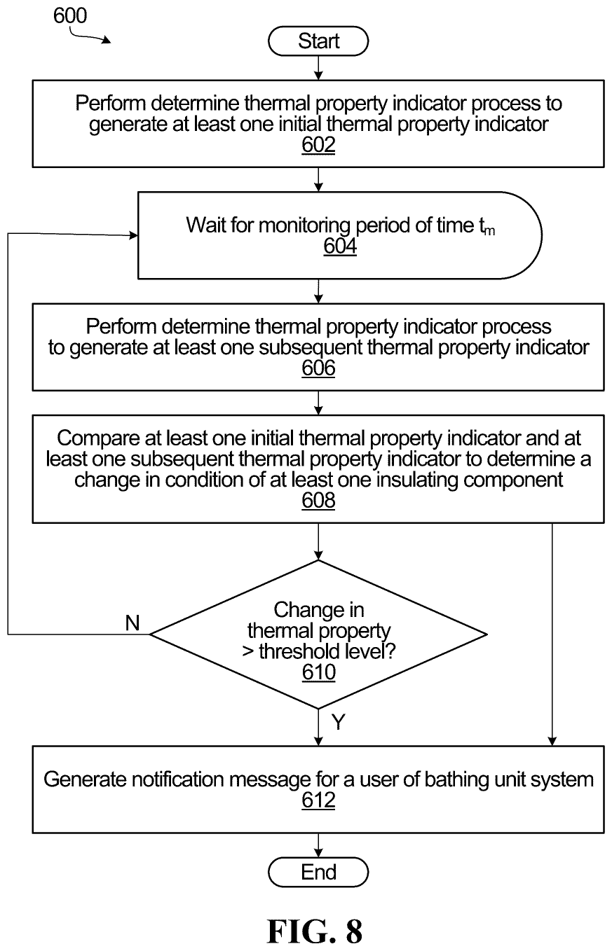

One embodiment of the monitor lifetime thermal properties process 600 is shown in FIG. 8. In some embodiments, the monitor lifetime thermal properties process 600 is performed by a combination of the local and remote processors 190 and 200 executing processor-readable instructions and/or computer-readable instructions stored in the program memory 194 and 204 as applicable. In other embodiments, the monitor lifetime thermal properties process 600 may comprise instructions stored on other types of non-transitory computer-readable storage medium. In yet other embodiments, the characterize the monitor lifetime thermal properties process 600 and/or parts thereof may be executed entirely by the local processor 190, executed entirely by the remote processor 200 and/or executed by a system other than the local and remote processors 190 and 200. Further, although the monitor lifetime thermal properties process 600 in accordance with one embodiment is described with reference to the flowchart illustrated in FIG. 8, other methods of implementing the monitor lifetime thermal properties process 600 may alternatively be used. For example, the order of execution of the blocks shown in FIG. 8 may be altered, and/or some of the blocks described may be altered, eliminated, or combined.

Referring to FIG. 8, the monitor lifetime thermal properties process 600 may begin at block 602, which may include computer-executable instructions directing the local processor 190 and/or the remote processor 200 to perform one iteration of the determine thermal properties process 300 over a first determination time period t_{d} in a manner similar to that described above in association with FIGS. 5A and 5B. In some situations, this iteration is a first iteration of the determine thermal properties process 300 ever performed for a particular bathing unit system 100 or a first iteration of the determine thermal properties process 300 performed for a particular bathing unit system 100 after installation at a field location of a user. In such situations, the determine thermal properties process 300 may generate an initial thermal property indicator for the bathing unit system 100. In other situations, this iteration may be any iteration of the determine thermal properties process 300 performed after the first iteration. In such situations, the determine thermal properties process 300 may generate at least one previously derived thermal property indicator of the bathing unit system 100.

After the one iteration of the determine thermal properties process 300 has been performed and at least one thermal property indicator of the particular bathing unit system 100 has been derived (e.g., thermal conductivity H of the particular bathing unit system 100, thermal resistance Θ of the particular bathing unit system 100, and/or k constant representative of proportionality factor that relates to a rate of cooling or rate of heating of a particular bathing unit system 100), block 602 may also direct the local processor 190 and/or the remote processor 200 to store the derived thermal property indicator in the thermal properties data store 303 or 313. In embodiments where the iteration is the first iteration of the determine thermal properties process 300 and the derived thermal property indicator is at least one initial thermal property indicator, block 602 may specifically direct the local processor 190 and/or the remote processor 200 to store the initial thermal property indicator associated with a “baseline” or “initial” tag indicating that the at least one initial thermal property indicator should be used as a baseline for at least some of comparison and monitoring of the thermal properties over the lifetime of the particular bathing unit system 100. In embodiments where the iteration is a subsequent iteration of the determine thermal properties process 300 and the derived thermal property indicator is at least one previously derived thermal property indicator, block 602 may direct the local processor 190 and/or the remote processor 200 to store the at least one previously derived thermal property indicator associated with a date and time of the determination.

The monitor lifetime thermal properties process 600 may they continue to block 604, which may include computer-executable instructions directing the local processor 190 and/or the remote processor 200 to wait for a monitoring time period of time tᵢₙ. In the embodiment shown, the monitoring time period tₘ is pre-set to a discrete amount of time (e.g., 7 days, 30 days, 3 months, 6 months, 12 months, etc.). However, in other embodiments, the monitoring time period tₘ may be varied based on a time of year, and may be longer during winter months when the particular bathing unit system 100 is not often used and shorter during summer months when the particular bathing unit system 100 is often used. In other embodiments, the monitoring time period tₘ may be varied based on weather events at the field location where the particular bathing unit system 100 is installed. For example, an end of the monitoring time period tₘ may be triggered immediately after a detected weather event (e.g., via the ambient temperature sensor 164 and/or other sensors of the at least one sensor 112, such as the wind speed sensor) or a predicted weather event (e.g., retrieved from the online weather sources by the local processor 190 or the remote processor 200 over the network 181) such as a heavy precipitation or heavy winds. In other embodiments, the monitoring time period tₘ may be varied based on age of the particular bathing unit system 100. For example, the monitoring time period tₘ may be longer when the particular bathing unit system 100 is new (e.g., within the first 5 years from installation at the field location of the user), shorter when the particular bathing unit system 100 is older (e.g., between 5-10 years) and even shorter when the particular bathing unit system 100 is even older (e.g., 10+years).

The monitor lifetime thermal properties process 600 may then continue to block 606, which may include computer-executable instructions directing the local processor 190 and/or the remote processor 200 to perform another iteration of the determine thermal properties process 300 over a subsequent determination time period t_{d} to generate at least one subsequent thermal property indicator for the bathing unit system 100 again in a manner similar to that described above in association with FIGS. 5A and 5B. This subsequent thermal property indicator may convey a current insulative capacity (e.g., correlated to a current condition) of the at least one insulating component 114 of the bathing unit system 100. After this other iteration of the determine thermal properties process 300 has been performed and the at least one (subsequent) current thermal property indicator has been derived, block 606 may also direct the local processor 190 and/or the remote processor 200 to store the at least one (subsequent) current thermal property indicator in the thermal properties data store 303 or 313, such as in association with a date and time of the determination.

The monitor lifetime thermal properties process 600 may then continue to block 608, which may include computer-executable instructions directing the local processor 190 and/or the remote processor 200 to compare the at least one current thermal property indicator derived at block 606 with either at least one initial thermal property indicator derived at block 604 or at least one previously derived thermal property indicator derived at a previous iteration of block 606, to determine a change in the thermal property indicator of the bathing unit system 100. For example, block 608 may direct the local processor 190 and/or the remote processor 200 to determine a percentage deterioration of the thermal properties of the at least one insulating component 114 by dividing a current thermal property indicator by the initial thermal property indicator or by a previously derived thermal property indicator. Additionally or alternatively, block 608 may also direct the local processor 190 and/or the remote processor 200 to determine a deterioration (or degradation) rate of thermal properties the particular bathing unit system 100 by subtracting the current thermal property indicator from the initial thermal property indicator or a previously derived thermal property indicator and dividing the difference by the monitoring time tₘ. One skilled in the art will appreciate that there are numerous alternative ways to assess a change in the thermal properties of a particular bathing unit system 100 based on a comparison between a current thermal property indicator derived at block 606 versus a reference thermal property indicator (e.g., at least one initial thermal property indicator or at least one previously derived thermal property indicator derived at blocks 604 or 606).

As described above, the thermal properties of a particular bathing unit system 100 depends significantly on a quality and condition (e.g., correlated to the insulative capacity) of the at least one insulating component 114 of the particular bathing unit system 100. As result, a change in the thermal properties of a particular bathing unit system 100 may be due to a change in the condition (e.g., correlated to the insulative capacity) of at least one insulating component 114 of the particular bathing unit system 100.

In this regard, the percentage change in the thermal property indicator may represent a percentage deterioration of the at least one insulating component 114 (e.g., relative to an initial condition of the insulating component 114 or a previously determined condition of the insulating component 114). Additionally or alternatively, the rate of change in a thermal property indicator may be correlated to a rate of deterioration of the insulating component 114 (e.g., again relative to the initial condition of the insulating component 114 or relative to a previously determined condition of the insulating component 114).

Block 608 may further include computer-executable instructions directing the local processor 190 and/or the remote processor 200 to store the change in the thermal property indicator in the thermal properties data store 303 or 313. Additionally or alternatively, the monitor lifetime thermal properties process 600 may continue straight to block 612, which may include computer-executable instructions directing the local processor 190 and/or the remote processor 200 to display or otherwise communicate the determined at least one current thermal property indicator, the determined change in the thermal property indicator to the user, the determined current condition of the at least one insulating component 114, and/or the determined change in condition of the at least one insulating component 114 (e.g., via the control panel 198 and/or the user device 184).

The monitor lifetime thermal properties process 600 may then continue to block 610, which may include computer-executable instructions directing the local processor 190 and/or the remote processor 200 to determine whether the change in the thermal properties exceed a threshold level. In certain embodiments, the threshold level may be a threshold percentage of deterioration (e.g., 75%, 50%, 25% etc.) of the at least one current thermal property indicator relative to the initial thermal property indicator and/or the previously derived thermal property indicator derived at block 604 or a previous iteration of block 606. In yet other embodiments, the threshold level may be a deterioration rate (e.g., 5%, 10%, 20%) of the current thermal property indicator relative to the initial thermal property indicator and/or the previously derived thermal property indicator derived at block 604 or a previous iteration of block 606. In yet other embodiments, there may be multiple threshold levels, including a deterioration threshold level indicating the threshold percentage of deterioration and/or the deterioration rate as noted above, and a missing threshold level indicating that a particular insulating component 114 (e.g., in particular the cover 170) is missing from the bathing unit system 100.

If at block 610, the local processor 190 and/or the remote processor 200 determines that the change in the thermal properties of the bathing unit system does not exceed the threshold level, the monitor lifetime thermal properties process 600 may return to block 604 to wait for the monitoring time period tₘ and continue as described above. However, if at block 610, the local processor 190 and/or the remote processor 200 determines that the change in the thermal property indicator does exceed the threshold level, the monitor lifetime thermal properties process 600 may continue to block 612, which may include computer-executable instructions directing the local processor 190 and/or the remote processor 200 to display or otherwise communicate a notification message to the user (e.g., via the control panel 198 and/or the user device 184). The notification message may convey a current condition of the at least one insulating component 114, that changes in the condition of the at least one insulating component 114 exceed the threshold level, the reference condition of the at least one insulating component 114 conveyed by the reference thermal property indicator (e.g., the initial thermal property indicator determined at block 602 or the previously derived thermal property indicator determined at a previous iteration of block 604), the current condition of the at least one insulating component 114 conveyed by the subsequent thermal property indicator (e.g., determined using a current iteration of block 606), the change information (e.g., determined at block 608), and/or that the at least one insulating component 114 should be replaced or repaired.

For example, as described above, a large portion of the total insulative capacity of the at least one insulating component 114 may depends on an insulative capacity (e.g., correlated to a condition) of the cover 170, as the cover 170 functions to cover the opening of the receptacle 102 from which a majority of the thermal energy in the water 103 can escape. Additionally, the different components of the cover 170 may be more likely to degrade than other insulating components, as the cover 170 is more exposed to the external environment and weather events at the top surface 173 and more exposed to humidity and condensation from the water 103 in the receptacle 102 at the bottom surface. As a result, the different components of the cover 170 are more likely to become damaged or otherwise lose insulating capacity (e.g., tears or other cracks in the covering 172 and absorption of water in the cover foam 171) when compared to other insulating components. As a result, in some embodiments, the notification message generated at block 612 may alert the user to the degradation of the cover 170 and prompt the user to repair or replace the cover 170. However, in other embodiments, the notification message generated at block 612 may alert the user to the degradation of other insulating components of the at least one insulating component 114, such as the cabinet insulation 176. In some embodiments, the notification message which is generated at block 612 may depend on an overall age of the particular bathing unit system 100. For example, a notification message generated while the particular bathing unit system 100 is new (e.g., within 5 years from installation) may recommend replacement of the cover 170. In contrast, a notification message generated while the particular bathing unit system 100 is old (e.g., 10+years from installation) may recommend replacement of the cover and cabinet insulation 176.

In yet other embodiments, the notification message generated at block 612 may depend on past replacements of the at least one insulating component 114. For example, in embodiments where the cover 170 was recently replaced but where the change in the thermal property indicator (e.g., determined by comparing the current thermal property indicator derived by an instance of the block 606 performed after the replacement of the cover 170 to the initial thermal property indicator derived at block 604 performed after the particular bathing unit system 100 was initially installed) is still large or past the threshold level at block 610, the notification message generated at block 612 may identify the cabinet insulation 176 for repair or replacement instead. Similarly, in embodiments where the cabinet insulation 176 was recently replaced but where the change in the current thermal property indicator relative to the initial thermal property indicator still large (e.g., still exceeds a threshold level), the notification message generated at block 612 may instead identify the cover 170 for replacement instead.

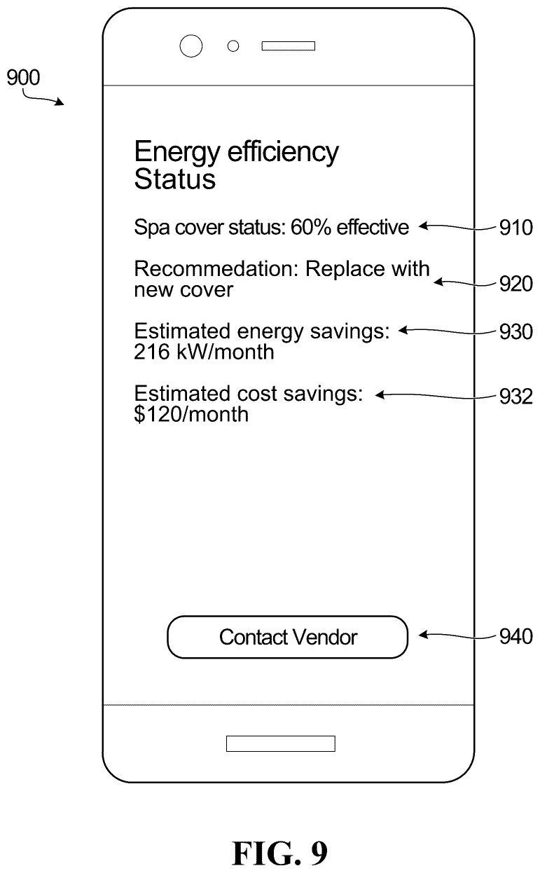

The notification message may convey, that changes in the condition of the at least one insulating component 114 exceed the threshold level, the reference condition of the at least one insulating component 114 conveyed by the reference thermal property indicator (e.g., the initial thermal property indicator determined at block 602 or the previously derived thermal property indicator determined at a previous iteration of block 604), a current condition of the at least one insulating component 114 conveyed by the subsequent thermal property indicator (e.g., determined using a current iteration of block 606), the change information (e.g., determined at block 608) and/or a recommendation that the at least one insulating component 114 should be replaced or repaired. The notification message may also convey that the at least one insulating component 114 (e.g., in particular the cover 170) is missing altogether. In some specific embodiments, the notification message may include condition information conveying one or more of: (a) a current condition of the at least one insulating component 114 (the cover 170 in the embodiment shown in FIG. 9); (b) a level of degradation of at least one insulating component 114, the level of degradation being derived from a change between a current thermal property indicator (e.g., the subsequent thermal property indicator determined using a current iteration of block 606) and a reference thermal property indicator (e.g., the initial thermal property indicator determined at block 602 or the previously derived thermal property indicator determined at a previous iteration of block 606); (c) that the at least one insulating component 114 should be replaced or repaired; and (d) calculated energy savings if the at least one insulating component 114 is replaced or repaired. The potential energy savings may be calculated by comparing an amount of input thermal energy Pᵢₙ required to heat the water 103 to a target bathing temperature T_{wat_final} based on the reference thermal property indicator (e.g., the initial thermal property indicator determined at block 602 or the previously derived thermal property indicator determined at a previous iteration of block 606) versus an amount of input thermal energy Pᵢₙ required based on the current thermal property indicator (e.g., the subsequent thermal property indicator determined using a current iteration of block 606).

The notification messages may be processed to render a user interface configured to present information conveying the condition information and a user-operable input element configured for receiving a user command initiating at least one of a repair process or a purchase process in connection with the at least one insulating component 114. For example, in response to receipt of the user command inputted via the user-operable element, the graphical user interface may be configured to establish a communication exchange with at least one of an online marketplace and a specific supplier for the at least one of the repair process or the purchase process in connection with the at least one insulating component 114. The communication exchange may be established between the user device 184 and at least one of the online marketplace or the specific supplier. The communication exchange may also be established between the control panel 198 and at least one of the online marketplace or the specific supplier the user device 184.

An example of a possible notification message is generally shown at 900 in FIG. 9. In the embodiment shown in FIG. 9, the notification message 900 includes condition information 910 indicating a percentage deterioration of the thermal properties of the at least one insulating component 114, a recommendation 920 suggesting that the at least one insulating component 114 should be replaced, an estimated energy savings 930 outlining the potential energy savings if the at least one insulating component 114 is replaced or repaired, an estimated cost savings 932 outline potential cost savings if the at least one insulating component 114 is replaced and repaired, and a user-operable input button 940 which may be selected by a user to initiate at least one of the repair processor the purchase process.

As a more specific example and referring to FIG. 9, as described above, the cover 170 may be represent approximately 50% of a total insulation of a particular bathing unit system 100. An average power Pᵢₙ required to maintain the water 103 of a particular bathing unit system 100 at a T_{wat} of approximately 40° C. given a T_{amb} of approximately 25° C. may be approximately 1.5 kW (e.g., determined using the power consumption models generated at block 402 and 406 of the characterize power consumption and energy output process 400. In a certain field location, the average cost for 1000 kW per month may be approximately $556 per month. In such a specific example, if block 608 of the monitor lifetime thermal properties process 600 determines that the cover 170 has degraded from a reference thermal property indicator indicating 100% efficiency to a subsequent thermal property indicator indicating 60% efficiency, the notification message 900 may indicate “60% effective” as the condition information 910. Block 612 of the monitor lifetime thermal properties process 600 may then calculate that the “60% effective” cover 170 will require an extra 40% of power to maintain the water 103 at the T_{wat} of 40° C., or specifically an extra 1.5 kW×0.5 (% of total insulation)×0.4 (% inefficiency)=0.3 kW. 0.3 kW may translate into 0.3 kW×24 (hours in a day)=7.2 kWh per day or approximately 7.2 kWh×30 (approximate days in a month)=216 kWh per month, which may in turn translate into additional costs of 216 kWh (extra power)/1000 kWh×$556 (cost of 1000 kWh)=$120. Other methods of determining extra power (and corresponding extra cost) required to maintain T_{wat} or required to reach a T_{wat_final} due to degradation of the at least one insulating component 114 will be known to those of ordinary skill in the art. The notification message 900 may then indicate “216 kWh/month” as the estimated energy savings 930 and “$120 savings/month” as the estimated cost savings 932.

In response to the notification message generated at block 612, the user may replace at least one insulating component of the at least one insulating component 114 (e.g., by selecting the user-operable input button 940). In some embodiments, the user may provide user input indicating replacement of at least one insulating component 114 (e.g., via the control panel 198 and/or the user device 184) to at least one of the local processor 190 and/or the remote processor 200. However, in other embodiments, the local processor 190 and/or the remote processor 200 may determine that at least one insulating component 114 have been replaced without user input, such as when one or more subsequent iterations of block 606 indicates that the thermal property indicator of the particular bathing unit system 100 conveys an improvement, rather than a degradation, in its condition. The monitor lifetime thermal properties process 600 may then return to and continue from block 606 as described above.

### CONCLUSION

The person skill in the art will appreciate that many variations to the embodiments described in the present document art possible and will become apparent from a reading of the present document concurrently with the figures.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including.” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control.

As used in the present disclosure, the terms “around”, “about”, “substantially” or “approximately” shall generally mean within the error margin generally accepted in the art. Hence, numerical quantities given herein generally include such error margin such that the terms “around”, “about” “substantially” or “approximately” can be inferred if not expressly stated. For greater clarity, unless otherwise explicitly stated, the terms “around”, “about”, “substantially” and “approximately” means a proportion of at least about 60%, or at least about 70% or at least about 80%, or at least about 90%, at least about 95%, at least about 97% or at least about 99% or more, or any integer between 70% and 100%.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”.

It refers to a list in which you may select: A or B or C, or both A and B, or both A and C, or both B and C, or all of A, B and C. The same principle applies for longer lists having a same format.

Although various embodiments of the invention have been described and illustrated, it will be apparent to those skilled in the art in light of the present description that numerous modifications and variations can be made. The scope of the invention is defined more particularly in the appended claims.

What is claimed is:

1. A method for operating one or more components in a bathing unit system at least in part based on thermal properties of the bathing unit system, wherein the bathing unit system further comprises a receptacle holding water and at least one insulating component insulating the receptacle, the method comprising:
a) deriving a thermal property indicator for the bathing unit system at least in part by processing changes in temperature of the water in the bathing unit system and/or deriving energy information corresponding to the one or more components, the thermal property indicator conveying a current condition of the at least one insulating component; and
b) controlling the one or more components to achieve a target bathing temperature based at least in part on the thermal property indicator.

2. The method of claim 1, wherein deriving the thermal property indicator comprises deriving the thermal property indicator by processing the changes in the temperature of the water and wherein processing the changes in the temperature of the water comprises:
a) activating a temperature change component for changing the temperature of the water to change the temperature of the water to a target calibration temperature;
b) deactivating the temperature change component responsive to the water reaching the target calibration temperature;
c) following deactivation of the temperature change component, deriving a rate of change of the temperature of the water at least in part by processing temperature measurements obtained by a sensor for measuring the temperature of the water at a plurality of determination time points over a determination time period; and
d) deriving the thermal property indicator for the bathing unit system at least in part by processing the rate of change of the temperature of the water.

3. The method of claim 2, wherein the temperature change component comprises at least one heater, and wherein:
a) activating the temperature change component comprises activating the at least one heater to increase the temperature of the water to the target calibration temperature; and
b) deactivating the temperature change component comprises deactivating the at least one heater prior to determining the rate of change of the temperature of the water, the rate of change of the temperature of the water conveying a rate of cooling of the water.

4. The method of claim 2, wherein the temperature change component comprises at least one cooler, and wherein:
a) activating the temperature change component comprises activating the at least one cooler to decrease the temperature of the water to the target calibration temperature; and
b) deactivating the temperature change component comprises deactivating the at least one cooler prior to determining the rate of change of the temperature of the water, the rate of change of the temperature of the water conveying a rate of heating of the water.

5. The method of claim 1, wherein deriving the thermal property indicator comprises deriving the energy information corresponding to the one or more components, and wherein deriving the energy information corresponding to the one or more components comprises:
a) deriving power consumption information of the one or more components based on a power consumption model generated for the one or more components, the power consumption model modelling an amount of power drawn by the one or more components from a power source and/or or an amount of power inputted by the one or more components into the water; and/or
b) deriving thermal energy information of the one or more components based on a thermal energy model generated for the one or more components, the thermal energy model modelling an amount of thermal energy inputted into the water and/or drawn from the water by the one or more components.

6. (canceled)

7. The method of claim 5, wherein the one or more components comprise a temperature change component for changing the temperature of the water and/or a pump for circulating the water through a circulation system of the bathing unit system.

8. The method of claim 1, wherein deriving the thermal property indicator further comprises processing a current ambient temperature of an environment around the bathing unit system.

9. The method of claim 1, further comprising:
a) retrieving extrinsic parameters of the bathing unit system, the extrinsic parameters including the thermal property indicator and at least one other extrinsic parameter;
b) receiving an input command conveying the target bathing temperature; and
c) adjusting control of the one or more components to achieve the target bathing temperature at least in part by processing the extrinsic parameters.

10. The method of claim 9, wherein the extrinsic parameters further comprises at least one of: a current water temperature of the water within the receptacle, a current water temperature of the water within the bathing unit system, a current ambient temperature of an environment around the bathing unit system, a forecasted ambient temperature of the environment around the bathing unit system, an amount of thermal energy inputted into or drawn from the bathing unit system over time based on thermal energy models of the one or more components, and a cost of energy associated with operating the one or more components based on power consumption models of the one or more components.

11. The method of claim 9- or 10, wherein the input command further comprises at least one of: an initial time point for activating the one or more components and a final time point at which the bathing unit system achieves the target bathing temperature.

12. The method of claim 1, wherein said thermal property indicator is a reference thermal property indicator conveying a reference condition of the at least one insulating component, said method further comprising:
a) deriving a subsequent thermal property indicator at a subsequent determination time point after a monitoring time period, the subsequent thermal property indicator conveying a subsequent current condition of the at least one insulating component after the monitoring time period; and
b) deriving change information for the thermal properties of the bathing unit system at least in part by comparing the subsequent thermal property indicator and the reference thermal property indicator.

13. The method of claim 12, wherein the change information conveys:
a) a percentage of deterioration of the at least one insulating component over the monitoring time period;
b) a rate of deterioration of the at least one insulating component over the monitoring time period; and/or
c) a change in condition of the at least one insulating component over the monitoring time period.

14. The method of claim 12, wherein the reference thermal property indicator is one of an initial thermal property indicator or a previously derived thermal property indicator.

15. The method of claim 12, further comprising adjusting control of the one or more components to achieve the target bathing temperature based at least in part on the change information and the subsequent thermal property indicator.

16. The method of claim 12, further comprising transmitting one or more notification messages to a user of the bathing unit system in response to the change information, the one or more notification messages conveying:
a) information derived by processing the subsequent thermal property indicator;
b) that changes in the thermal properties of the bathing unit system exceed a threshold level;
c) the reference condition of the at least one insulating component conveyed by the reference thermal property indicator;
d) the subsequent current condition of the at least one insulating component conveyed by the subsequent thermal property indicator;
e) the change information; and/or
f) that the at least one insulating component should be replaced or repaired.

17. The method of claim 1, wherein the at least one insulating component comprises at least one of a cover of the bathing unit system, a receptacle insulation of the bathing unit system or a cabinet insulation of the bathing unit system.

18. A system for operating one or more components in a bathing unit system at least in part based on thermal properties of the bathing unit system, wherein the bathing unit system further comprises a receptacle holding water and at least one insulating component insulating the receptacle, the system comprising:
a) at least one processor; and
b) a memory storing processor-executable instructions that, when executed, cause the at least one processor to perform the method of claim 1.

19-41. (canceled)

42. A method for monitoring at least one insulating component of a bathing unit system, the bathing unit system comprising a receptacle for holding water and one or more components for operating the bathing unit system, the at least one insulating component providing insulation of the receptacle, the method comprising:
a) deriving a reference thermal property indicator for the bathing unit system at least in part by processing changes in a temperature of the water over a determination time period and/or deriving energy information corresponding to the one or more components over the determination time period, wherein the reference thermal property indicator comprises one of an initial reference thermal property indicator and a previously derived thermal property indicator and conveys a reference condition of the at least one insulating component;
b) waiting a monitoring time period;
c) repeating step a) after the monitoring time period to derive a subsequent thermal property indicator, the subsequent thermal property indicator conveying a current condition of the at least one insulating component after the monitoring time period;
d) deriving change information conveying changes in a condition of the at least one insulating component over the monitoring time period derived at least in part by comparing the subsequent thermal property indicator and the reference thermal property indicator; and
e) transmitting one or more notification messages to a user of the bathing unit system in response to the change information, the one or more notification messages conveying:
i) that the changes in the condition of the at least one insulating component exceed a threshold level;
ii) the reference condition of the at least one insulating component conveyed by the reference thermal property indicator;
iii) the current condition of the at least one insulating component conveyed by the subsequent thermal property indicator;
iv) the change information; and/or
v) that the at least one insulating component should be replaced or repaired.

43. The method of claim 42, wherein deriving the reference thermal property indicator comprises deriving the reference thermal property indicator by processing the changes in the temperature of the water within the receptacle over the determination time period and wherein processing the changes in temperature of the water comprises:
a) activating a temperature change component for changing a temperature of the water to change the temperature of the water to a target calibration temperature;
b) deactivating the temperature change component responsive to the water reaching the target calibration temperature;
c) following deactivation of the temperature change component, deriving a rate of change of the temperature of the water at least in part by processing temperature measurements obtained by a sensor for measuring the changes in the temperature of the water at a plurality of determination time points over the determination time period; and
d) deriving the reference thermal property indicator for the bathing unit system at least in part by processing the rate of change of the temperature of the water.

44. The method of claim 43, wherein the temperature change component comprises at least one heater, and wherein determining the rate of change of the temperature of the water comprises determining a rate of cooling of the water after the temperature of the water reaches the target calibration temperature and after the at least one heater is deactivated.

45. The method of claim 43, wherein the temperature change component comprises at least one cooler and wherein determining the rate of change of the temperature of the water comprises determining a rate of heating of the temperature of the water after the temperature of the water reaches of the target calibration temperature and after the at least one cooler is deactivated.

46. The method of claim 42, wherein deriving the reference thermal property indicator comprises deriving the energy information corresponding to the one or more components and wherein deriving the energy information corresponding to the one or more components comprises:
a) deriving power consumption information of the one or more components based on a power consumption model generated for the one or more components, the power consumption model modelling an amount of power drawn by the one or more components from a power source and/or an amount of power inputted by the one or more components into the water; and/or
b) deriving thermal energy information of the one or more components based on a thermal energy model generated for the one or more components, the thermal energy model modelling an amount of thermal energy inputted into the water and/or drawn from the water by the one or more components.

47. (canceled)

48. The method of claim 46, wherein the one or more components comprise a temperature change component for changing a temperature of the water and/or a pump for circulating the water through a circulation system of the bathing unit system.

49. The method of claim 42, wherein deriving the reference thermal property indicator further comprises processing a current ambient temperature of an environment around the bathing unit system.

50. The method of claim 42, wherein the change information conveys:
a) a percentage of deterioration of thermal insulation of the at least one insulating component over the monitoring time period; and/or
b) a rate of deterioration of thermal insulation of the at least one insulating component over the monitoring time period.

51. The method of claim 42, wherein the at least one insulating component comprises at least one of a cover of the bathing unit system, a receptacle insulation of the bathing unit system or a cabinet insulation of the bathing unit system, and wherein deriving the change information comprises:
a) determining changes in a condition of the cover;
b) determining changes in a condition of the receptacle insulation; and/or
c) determining changes in a condition of the cabinet insulation.

52. The method of claim 42, wherein the one or more notification messages are in the form of SMS text messages sent to a personal communication device associated with the user, wherein the SMS text messages include a user-operable input for establishing a communication exchange with at least one of an online marketplace and a specific supplier.

53. The method of claim 42, wherein the one or more notification messages are configured for rendering a graphical user interface on a display screen of a user device, the graphical user interface presenting a user with:
i) information derived from the one or more notification messages; and
ii) a user-operable input element configured for receiving a user command initiating at least one of a repair process or a purchase process in connection with the at least one insulating component.

54. A system for monitoring at least one insulating component of a bathing unit system, the bathing unit system comprising a receptacle for holding water and one or more components for operating the bathing unit system, the at least one insulating component providing insulation of the receptacle, the system comprising:
a) at least one processor; and
b) a memory storing processor-executable instructions that, when executed, cause the at least one processor to perform the method of claim 42.

55-65. (canceled)

66. A non-transitory computer-readable storage medium having stored thereon processor-executable instruction that, when executed, cause at least one processor to perform operations comprising:
a) receiving a notification message from a system monitoring an insulating component of a bathing unit system including condition information corresponding to the insulating component, the condition information conveying:
i) a current condition of the insulating component; and/or
ii) a level of degradation of the insulating component, the level of degradation being derived from a change between a current thermal property indicator for the insulating component and a reference thermal property indicator for the insulating component;
iii) that the insulating component should be replaced or repaired; and/or
iv) that the insulating component is missing; and
b) processing the notification message to render a graphical user interface on a display screen of a user device, said graphical user interface presenting a user with:
i) information conveying the condition information corresponding to the insulating component; and
ii) a user-operable input element configured for receiving a user command initiating at least one of a repair process or a purchase process in connection with the insulating component.

67. The non-transitory computer-readable storage medium of claim 66, wherein the reference thermal property indicator comprises an initial thermal property indicator or a previously derived thermal property indicator.

68. The non-transitory computer-readable storage medium of claim 66, er 67, wherein the user-operable input element is presented in response to the condition information conveying that the insulating component should be replaced or repaired.

69. The non-transitory computer-readable storage medium of claim 66, the operations further comprising, in response to receipt of the user command, establishing a communication exchange with at least one of an online marketplace and a specific supplier for the at least one of the repair process or the purchase process in connection with the insulating component, the communication exchange being established between the user device and at least one of the online marketplace or the specific supplier.

70. The non-transitory computer-readable storage medium of claim 66, wherein the insulating component comprises one of a receptacle insulation element, a cabinet insulation element or a cover.

71. (canceled)

72. The non-transitory computer-readable storage medium of claim 66, wherein the user device includes at least one of a top-side bathing unit control panel, a tablet, a smartphone and a computer device.
